(19) United States
(12) Patent Application Publication
(10) Pub. No.: US 2020/0042124 A1
(43) Pub. Date: Feb. 6, 2020

(54) ORGANIC ELECTROLUMINESCENCE MODULE, SMART DEVICE, AND ILLUMINATION APPARATUS

(71) Applicant: Konica Minolta, Inc., Tokyo (JP)

(72) Inventors: Kazuyoshi OMATA, Kouhu-shi, Yamanashi (JP); Tsukasa YAGI, Higashinada-ku, Kobe-shi, Hyogo (JP)

(21) Appl. No.: 15/735,815

(22) PCT Filed: Mar. 14, 2016
(86) PCT No.: PCT/JP2016/057971

§ 371 Date: Dec. 12, 2017

(30) Foreign Application Priority Data
Jun. 22, 2015 (JP) 2015-124498

(51) Int. Cl. G06F 3/041; G06F 3/044; G09G 3/3208

(52) U.S. Cl. CPC G06F 3/0412; G06F 3/0446; G09G 2330/04; G06F 3/04166; G06F 2203/04107; G09G 3/3208

(57) ABSTRACT

Provided is an organic electroluminescence module including: an organic electroluminescence element including a pair of electrodes and an organic light emitting function layer disposed between the electrodes; an electroluminescence element driving circuit unit that is connected to the pair of electrodes and controls light emission of the organic electroluminescence element; and a touch position detecting circuit unit connected to both ends in a touch position detection direction of one of the pair of electrodes that serves as detection electrodes, wherein the detection electrodes are arranged separately in the touch position detection direction, and the touch position detecting circuit unit detects, for each of the detection electrodes, an electric signal input from an input end that is one of the ends of the detection electrode at an output end that is the other end of the detection electrode to perform touch position detection at at least one location in the touch position detection direction.

### TECHNICAL FIELD

The present invention relates to an organic electroluminescence module that has a touch detection function, and a smart device and an illumination apparatus provided with the same.

### BACKGROUND ART

It is necessary for smart devices such as smartphones and tablets to include a touch sensor for enabling information input from a display unit. For example, the touch sensor is disposed overlapping the display unit.

A smart device may be provided with a “home key” indicated by, for example, a rectangular mark and a common function key button (i.e., an icon) such as a “return key” indicated by, for example, an arrow mark in addition to a main display unit in view of the operability thereof. The common function key button includes a planar light source body corresponding to a pattern shape of a mark to be displayed in view of improving the visibility. As an example, there is disclosed a configuration in which an LED light-guiding plate which is a combination of a light emitting diode (LED) and a light-guiding plate is installed inside a smart device (e.g., refer to Patent Literature 1 described below).

In a smart device, the touch sensor is disposed also overlapping the common function key button as described above. The touch sensor is commonly used with the main display unit which includes, for example, a liquid crystal display device.

However, in recent years, an “in-cell” type or “on-cell” type liquid crystal display device which includes a built-in sensor electrode has made its debut as a liquid crystal display device used as a main display unit. Accordingly, it is strongly requested for the planar light source body which constitutes the common function key button to have an independent touch detection function.

As the planar light source body with a touch detection function, for example, there is disclosed a configuration in which a circuit board which includes a sensor electrode is disposed between a display panel provided with an icon and an LED light-guiding plate, a through hole is formed on a part of the circuit board where the icon is formed, and an adhesive layer having a high dielectric constant is formed between the display panel and the circuit board to improve the accuracy of the detection of a capacitance by the sensor electrode (e.g., refer to Patent Literature 2 described below).

### CITATION LIST

### Patent Literature

Patent Literature 1: JP 2012-194291 A

Patent Literature 2: JP 2013-065429 A

### SUMMARY OF INVENTION

### Technical Problem

In recent years, there has been a move to use an organic electroluminescence device instead of an LED light-guiding plate as the above planar light source body used in the icon part. An organic electroluminescence device is a surface emitting element which includes an organic light emitting function layer held between an anode and a cathode and capable of obtaining surface light emission having a highly uniform light emission luminance with a lower power consumption.

However, when a touch sensor is disposed overlapping the organic electroluminescence device, the anode, the cathode, or a metal foil layer used for protection adversely affects detection of a change in a capacitance generated between a sensor electrode and a touch surface. Thus, when a capacitance type touch function is imparted to an organic electroluminescence device, it is necessary to install a touch panel provided with a touch sensor as a body separated from a display panel provided with the organic electroluminescence device, which is a factor interfering with thinning of the device and a reduction in the number of manufacturing steps.

In view of the above, it is an object of the present invention to provide an organic electroluminescence module with a touch function that makes it possible to achieve thinning and a reduction in the number of manufacturing steps, and a smart device and an illumination apparatus using the same.

### Solution to Problem

To achieve such object, according to the present invention, there is provided an organic electroluminescence module including: an organic electroluminescence element including a pair of electrodes and an organic light emitting function layer disposed between the electrodes; an electroluminescence element driving circuit unit that is connected to the pair of electrodes and controls light emission of the organic electroluminescence element; and a touch position detecting circuit unit connected to both ends in a touch position detection direction of one of the pair of electrodes that serves as detection electrodes, wherein the detection electrodes are arranged separately in the touch position detection direction, and the touch position detecting circuit unit detects, for each of the detection electrodes, an electric signal input from an input end that is one of the ends of the detection electrode at an output end that is the other end of the detection electrode to perform touch position detection at at least one location in the touch position detection direction.

Further, the present invention also provides a smart device and an illumination apparatus provided with the organic electroluminescence module having such a configuration.

### Advantageous Effects of Invention

According to the present invention as described above, it is possible to obtain an organic electroluminescence module with a touch function that makes it possible to achieve thinning and a reduction in the number of manufacturing steps, and a smart device and an illumination apparatus using the same.

### BRIEF DESCRIPTION OF DRAWINGS

FIG. 1 is a configuration diagram for describing an organic electroluminescence module of a first embodiment and for describing a light emission period.

FIG. 2 is a configuration diagram for describing a touch position detection period in the first embodiment.

FIG. 3 is a timing chart for describing an operation of the organic electroluminescence module of the first embodiment (first example).

FIG. 4 is a timing chart for describing an operation of the organic electroluminescence module of the first embodiment (second example).

FIG. 5 is a configuration diagram for describing an organic electroluminescence module of a second embodiment and for describing a light emission period.

FIG. 6 is a configuration diagram for describing a touch position detection period in the second embodiment.

FIG. 7 is a timing chart for describing an operation of the organic electroluminescence module of the second embodiment.

FIG. 8 is a configuration diagram for describing an organic electroluminescence module which is a combination of the second embodiment and the first embodiment and for describing a light emission period.

FIG. 9 is a configuration diagram for describing an organic electroluminescence module of a third embodiment and for describing a light emission period.

FIG. 10 is a configuration diagram for describing a touch position detection period in the third embodiment.

FIG. 11 is a timing chart for describing an operation example of the organic electroluminescence module of the third embodiment.

FIG. 12 is a configuration diagram for describing an organic electroluminescence module of a fourth embodiment.

FIG. 13 is a schematic plan view of the fourth embodiment.

FIG. 14 includes FIGS. 14A and 14B which are diagrams describing a method for detecting a touch position in the organic electroluminescence module of the fourth embodiment.

FIG. 15 is a plan view for describing a third application example of the organic electroluminescence module of the present invention.

FIG. 16 is a plan view illustrating an example of a smart device provided with the organic electroluminescence module of the present invention.

### DESCRIPTION OF EMBODIMENTS

Hereinbelow, embodiments of an organic electroluminescence module, a smart device, and an illumination apparatus of the present invention will be described with reference to the drawings. The organic electroluminescence module described herein is an organic electroluminescence device provided with a capacitive touch detection function in which information is input by contact of, for example, a finger with a display surface thereof. The smart device and the illumination apparatus are provided with the organic electroluminescence module. Hereinbelow, embodiments of the organic electroluminescence module will be described in order.

### First Embodiment

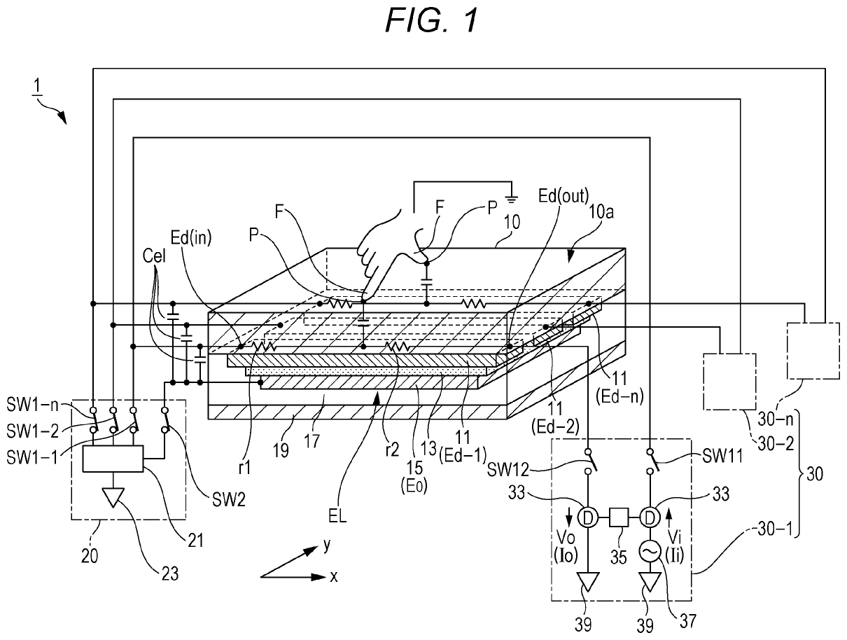

FIG. 1 is a configuration diagram for describing an organic electroluminescence module 1 of a first embodiment. The organic electroluminescence module 1 illustrated in FIG. 1 is provided with an organic electroluminescence element EL which is disposed on one principal face of a support substrate 10, an electroluminescence element driving circuit unit 20, and a touch position detecting circuit unit 30. The organic electroluminescence module 1 has a touch detection function for detecting a touch position P on the surface of the support substrate 10. Hereinbelow, details of these components will be described.

<Organic Electroluminescence Element EL>

The organic electroluminescence element EL includes a lower electrode 11, an organic light emitting function layer 13, and an upper electrode 15 which are stacked in this order from the support substrate 10. That is, the organic light emitting function layer 13 is disposed between the lower electrode 11 and the upper electrode 15. In the organic electroluminescence element EL having such a configuration, a part where the organic light emitting function layer 13 is held between the lower electrode 11 and the upper electrode 15 serves as a light emitting region. Further, the organic electroluminescence element EL has a capacitor configuration and thus has a parasitic capacitance Cel.

The organic electroluminescence element EL is covered and sealed with a sealing adhesive 17 from the side corresponding to the upper electrode 15, and further includes a sealing member 19 which is disposed on the surface of the sealing adhesive 17 for the purpose of preventing penetration of harmful gas (e.g., oxygen and moisture) from an external environment. In this manner, a single display panel is formed. In the organic electroluminescence element EL having such a configuration, either the lower electrode 11 or the upper electrode 15 is an anode, and the other one is a cathode. Light is emitted in the organic light emitting function layer 13 by passing a current in the forward direction between the lower electrode 11 and the upper electrode 15. Hereinbelow, details of each of the components of the organic electroluminescence element EL will be described. Application of a constant current or a constant voltage to the organic electroluminescence element EL in the forward direction corresponds to a state in which a voltage is applied with the anode as plus and the cathode as minus. The same applies to the following description.

—Support Substrate 10—

Here, the support substrate 10 is made of, for example, a material having a light transmission property. The surface of the support substrate 10 serves as a display surface from which light emitted in the organic light emitting function layer 13 is extracted. The display surface also serves as a touch surface 10a to which information is input by contact of, for example, a fingertip or a touch pen (hereinbelow, referred to as a fingertip F). Hereinbelow, the information input by the contact of the fingertip F with respect to the touch surface 10a is referred to as a touch operation.

Examples of the transparent substrate material which constitutes the support substrate 10 as described above include glass and plastics. Examples of a preferably-used transparent substrate material include glass, quartz, and a resin film in view of flexibility. The support substrate 10 may include a gas barrier layer as needed. Further, a cover glass may be bonded to the display surface side of the support substrate 10 as needed. In this case, the surface of the cover glass serves as the touch surface 10a.

—Lower Electrode 11—

The lower electrode 11 is configured as transparent electrode on the light extraction side. The lower electrode 11 is provided as the anode or the cathode for the organic light emitting function layer 13. The lower electrode 11 is used as the anode when the upper electrode 15 is used as the cathode and used as the cathode when the upper electrode 15 is used as the anode. The lower electrode 11 having such a configuration is made of a conductive material that is suitable for the anode or the cathode and has an excellent light transmission property.

Here, in particular, the lower electrode 11 is disposed closer to the touch surface 10a than the upper electrode 15 is. Thus, the lower electrode 11 is preferably used as detection electrodes Ed-1, Ed-2, . . . and Ed-n for detecting a touch position P. The plurality of detection electrodes Ed-1, Ed-2, . . . and Ed-n are arranged separately in a first touch position detection direction y. Thus, the lower electrode 11 is also divided into a plurality of pieces corresponding to the number of detection electrodes Ed-1, Ed-2, . . . and Ed-n. The electroluminescence element driving circuit unit 20 and the touch position detecting circuit unit 30 are connected to the pieces of the lower electrode 11 which constitute the respective detection electrodes Ed-1, Ed-2, . . . and Ed-n having such a configuration. A connected state between these components will be described below.

—Organic Light Emitting Function layer 13—

The organic light emitting function layer 13 includes at least a light emitting layer made of an organic material. An entire layer structure of the organic light emitting function layer 13 is not limited to any structure and may be a common layer structure. Examples of the organic light emitting function layer 13 are shown below, but not limited thereto.

(i) (anode)/hole injection transport layer/light emitting layer/electron injection transport layer/(cathode)

(ii) (anode)/hole injection transport layer/light emitting layer/hole blocking layer/electron injection transport layer/(cathode)

(iii) anode/hole injection transport layer/electron blocking layer/light emitting layer/hole blocking layer/electron injection transport layer/(cathode)

(iv) (anode)/hole injection layer/hole transport layer/light emitting layer/electron transport layer/electron injection layer/(cathode)

(v) (anode)/hole injection layer/hole transport layer/light emitting layer/hole blocking layer/electron transport layer/electron injection layer/(cathode)

(vi) (anode)/hole injection layer/hole transport layer/electron blocking layer/light emitting layer/hole blocking layer/electron transport layer/electron injection layer/(cathode)

The light emitting layer may have a laminated structure and may include a non-light emitting intermediate layer held between the laminated light emitting layers. The intermediate layer may be a charge generating layer or may have a multiphoton unit configuration.

—Upper Electrode 15—

The upper electrode 15 is provided as the cathode or the anode for the organic light emitting function layer 13. The upper electrode 15 is used as the cathode when the lower electrode 11 is used as the anode and used as the anode when the lower electrode 11 is used as the cathode. The upper electrode 15 having such a configuration is configured as a transparent electrode when the organic electroluminescence element EL extracts emitted light also from the side corresponding to the upper electrode 15. On the other hand, when emitted light is extracted only from the lower electrode 11, the upper electrode 15 is configured as a reflective electrode. Thus, the upper electrode 15 is made of a conductive material that is suitable for the cathode or the anode and has an excellent light transmission property or an excellent light reflection property.

The upper electrode 15 having such a configuration is connected to the electroluminescence element driving circuit unit 20 together with the lower electrode 11. A connected state of the electroluminescence element driving circuit unit 20 with respect to the upper electrode 15 will be described below. Further, the upper electrode 15 also serves as a counter electrode Eo with respect to each of the detection electrodes Ed-1, Ed-2, . . . and Ed-n which constitute the lower electrode 11.

Here, the surface facing the outside in the support substrate 10 is used as the touch surface 10a. However, the surface facing the outside in the sealing member 19 opposite to the support substrate 10 may be used as a touch surface. In this case, the upper electrode 15 closer to the touch surface is preferably used as the detection electrodes Ed-1, Ed-2, . . . and Ed-n. Further, in this case, each upper electrode 15 is configured as a transparent electrode, and the lower electrode 11 serves as a counter electrode Eo. It is sufficient for the lower electrode 11 used as the counter electrode Eo to be disposed facing the plurality of detection electrodes Ed-1, Ed-2, . . . and Ed-n, and it is not necessary to divide the lower electrode 11.

—Sealing Adhesive 17—

The sealing adhesive 17 is used as a sealing agent for sealing the organic electroluminescence element EL held between the sealing member 19 and the support substrate 10. Specifically, as the sealing adhesive 17 having such a configuration, a photo-curable and thermosetting adhesive having reactive vinyl groups of an acrylic oligomer and a methacrylic oligomer, a moisture-curable adhesive such as 2-cyanoacrylic ester, or a thermosetting and chemically-curable (two-liquid mixed) epoxy adhesive is used, and a drying agent may be dispersed therein.

—Sealing Member 19—

It is sufficient for the sealing member 19 to cover a display region of the organic electroluminescence element EL. The sealing member 19 may have a recessed plate-like shape or a flat plate-like shape. The transparency and the electrical insulating property of the sealing member 19 are not particularly limited to any transparency and any electoral insulating property. Specifically, examples of the sealing member 19 include a glass plate, a polymer plate, a film, a metal plate, and a film. In view of thinning the organic electroluminescence module 1, a polymer film and a metal film can be preferably used. However, when a polymer film is used, it is important for the polymer film to have a low water vapor transmittance.

The present invention is not limited to filling a gap between the sealing member 19 and the organic electroluminescence element EL with the sealing adhesive 17. In particular, it is preferred that an inert gas such as nitrogen or argon be sealed in the display region (light emitting region) in the case of a gas phase and an inert liquid such as fluorohydrocarbon or a silicon oil be injected in the display region in the case of a liquid phase. Further, the gap between the sealing member 19 and the display region of the organic electroluminescence element EL may be made vacuous, or a hygroscopic compound may be sealed in the gap.

Here, the surface facing the outside in the support substrate 10 is used as the touch surface 10a. However, the surface facing outside in the sealing member 19 may be used as a touch surface. In this case, the sealing member 19 is made of a material having a light transmission property.

<Electroluminescence Element Driving Circuit Unit 20>

The electroluminescence element driving circuit unit 20 is capable of controlling light emission of the organic electroluminescence element EL and setting the upper electrode 15 as the counter electrode Eo at a floating potential. Here, the electroluminescence element driving circuit unit 20 has a configuration in which the connection with the lower electrode 11 and the upper electrode 15 is freely released. The electroluminescence element driving circuit unit 20 having such a configuration is provided with a light emission driving circuit 21 which is connected to each of the pieces of the lower electrode 11 and the upper electrode 15 of the organic electroluminescence element EL, switches SW1-1, SW1-2, . . . and SW1-n which are disposed between the light emission driving circuit 21 and the respective pieces of the lower electrode 11, and a switch SW2 which is disposed between the light emission driving circuit 21 and the upper electrode 15. The light emission driving circuit 21 is connected to a ground 23. Details of each of the components are as follows.

—Switches SW1-1, SW1-2, . . . and SW1-n and Switch SW2—

The switches SW1-1, SW1-2, . . . and SW1-n are used for freely controlling a connected state between the light emission driving circuit 21 and each of the pieces of the lower electrode 11. Each of the switches SW1-1, SW1-2, . . . and SW1-n having such a configuration includes, for example, a thin film transistor (TFT) and a control circuit which controls driving of the TFT. In this case, in each of the switches SW1-1, SW1-2, . . . and SW1-n, either a source or a drain of the TFT is connected to the light emission driving circuit 21, and the other one is connected to the corresponding piece of the lower electrode 11. A gate electrode of the TFT is connected to the control circuit. Accordingly, the connected state between the light emission driving circuit 21 and each of the pieces of the lower electrode 11 is freely controlled by voltage applied to the gate electrode of the TFT.

The switch SW2 is used for freely controlling a connected state between the light emission driving circuit 21 and the upper electrode 15. The switch SW2 having such a configuration includes, for example, a thin film transistor (TFT) and a control circuit which controls driving of the TFT. In this case, in the switch SW2, either a source or a drain of the TFT is connected to the light emission driving circuit 21, and the other one is connected to each upper electrode 15. A gate electrode of the TFT is connected to the control circuit. Accordingly, the connected state between the light emission driving circuit 21 and each upper electrode 15 is freely controlled by voltage applied to the gate electrode of the TFT.

Here, a state in which the light emission driving circuit 21 are connected to the lower electrode 11 and the upper electrode 15 by driving the switches SW1-1, SW1-2, . . . and SW1-n and the switch SW2 is defined as an “ON” state of the switches SW1-1, SW1-2, . . . and SW1-n and the switch SW2. On the other hand, a state in which the connection between the light emission driving circuit 21 and the lower electrode 11 is released by driving the switches SW1-1, SW1-2, . . . and SW1-n and the switch SW2 is defined as an “OFF” state of the switches SW1-1, SW1-2, . . . and SW1-n and the switch SW2.

The “ON” state of the switches SW1-1, SW1-2, . . . and SW1-n and the switch SW2 enables the light emission driving circuit 21 to control light emission of the organic electroluminescence element EL. The “OFF” state of the switches SW1-1, SW1-2, . . . and SW1-n and the switch SW2 releases the connections between the light emission driving circuit 21 and the lower electrode 11 and the upper electrode 15 of the organic electroluminescence element EL. Accordingly, the upper electrode 15 as the counter electrode Eo can be set at a floating potential.

The control of “ON”/“OFF” of the switches SW1-1, SW1-2, . . . and SW1-n and the switch SW2 as described above is performed synchronously with switches SW11 and SW12 of the touch position detecting circuit unit 30 as described below with reference to timing charts. FIG. 1 illustrates a configuration in which the light emission driving circuit 21 and the switches SW1-1, SW1-2, . . . and SW1-n and the switch SW2 are separated from each other. However, the switches SW1-1, SW1-2, . . . and SW1-n and the switch SW2 may be incorporated in the light emission driving circuit 21 as needed. Further, the control circuits of the switches SW1-1, SW1-2, . . . and SW1-n and the switch SW2 may be an external operation device.

—Ground 23—

The ground 23 may either be a signal ground including a circuit pattern or be a frame ground such as a metal case on which the organic electroluminescence module 1 is disposed.

<Touch Position Detecting Circuit Unit 30>

The touch position detecting circuit unit 30 includes detection units 30-1, 30-2, . . . and 30-n which are respectively connected to the detection electrodes Ed-1, Ed-2, . . . and Ed-n constituted of the respective pieces of the lower electrode 11 of the organic electroluminescence element EL. All the detection units 30-1, 30-2, . . . and 30-n have the same configuration. Thus, in particular, the configuration of the detection unit 30-1 which is connected to the detection electrode Ed-1 will be described as an example hereinbelow.

The detection unit 30-1 is connected to both ends in a second touch position detection direction x, which differs from the first touch position detection direction y, of the detection electrode Ed-1. The detection unit 30-1 performs touch position detection with one of the ends in the touch position detection direction x of the detection electrode Ed-1 (lower electrode 11) as an input end Ed (in) and the other end thereof as an output end Ed (out).

The detection unit 30-1 having such a configuration is provided with the switches SW11 and SW12 which are connected to the respective ends of the detection electrode Ed-1, detectors 33 which are connected to the detection electrode Ed-1 through the respective switches SW11 and SW12, an operation unit 35, and a power source 37. The detectors 33 and the power source 37 are connected to a ground 39. Details of each of the components are as follows.

—Switches SW11 and SW12—

The switch SW11 is connected to the input end Ed (in) of the detection electrode Ed-1. The switch SW12 is connected to the output end Ed (out) of the detection electrode Ed-1. The switches SW11 and SW12 are used for freely controlling a connected state between the respective ends of the detection electrode Ed-1 and the two detectors 33. Each of the switches SW11 and SW12 having such a configuration includes, for example, a thin film transistor (TFT) and a control circuit which controls driving of the TFT. In this case, in each of the switches SW11 and SW12, either a source or a drain of the TFT is connected to the detection electrode Ed-1, and the other one is connected to the detector 33. A gate electrode of the TFT is connected to the control circuit. Accordingly, a connected state between the input end Ed (in) of the detection electrode Ed-1 and one of the detectors 33 and a connected state between the output end Ed (out) of the detection electrode Ed-1 and the other detector 33 are freely controlled by voltage applied to the gate electrodes of the TFTs.

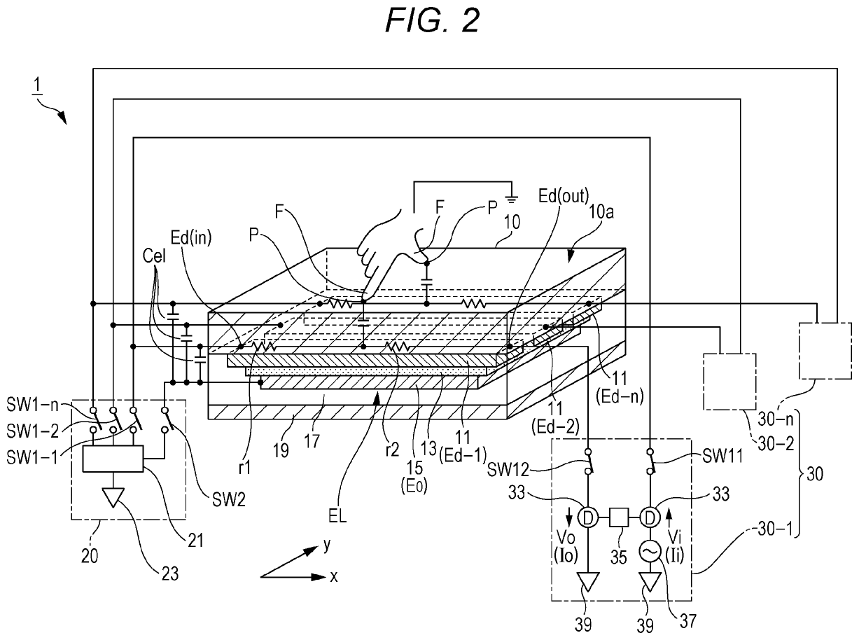

Here, a state in which the detection electrode Ed-1 is connected to the detectors 33 by driving the switches SW11 and SW12 is defined as an “ON” state of the switches SW11 and SW12 (refer to FIG. 2). On the other hand, a state in which the connection between the detection electrode Ed-1 and the detectors 33 is released by driving the switches SW11 and SW12 is defined as an “OFF” state of the switches SW11 and SW12.

—Detectors 33—

The respective detectors 33 are connected to the input end Ed (in) and the output end Ed (out) of the detection electrode Ed-1 through the switches SW11 and SW12. Each of the detectors 33 is either a voltmeter or an ammeter. The detectors 33 measure voltage values or current values applied to the input end Ed (in) and the output end Ed (out) of the detection electrode Ed-1 as electric signals.

—Operation Unit 35—

The operation unit 35 detects whether a touch operation has been performed to a position corresponding to the detection electrode Ed-1 on the touch surface 10a from waveforms of electric signals measured by the two detectors 33. That is, the operation unit 35 of each of the detection units 30-1, 30-2, . . . and 30-n individually detects whether a touch operation has been performed to a position corresponding to each of the detection electrodes Ed-1, Ed-2, . . . and Ed-n in the first touch position detection direction y on the touch surface 10a. Thus, the touch position P in the first touch position detection direction y can be detected by detecting any of the detection electrodes Ed-1, Ed-2, . . . and Ed-n to which a touch operation has been performed. The detection of the touch position P in the first touch position detection direction y is individually performed in each of the detection electrodes Ed-1, Ed-2, . . . and Ed-n. Thus, multipoint detection which simultaneously detects a plurality of touch positions P, that is, multi-touch detection can be performed in the first touch position detection direction y.

The operation unit 35 detects a position in the second touch position detection direction x on the touch surface 10a to which a touch operation has been performed in the detection electrode Ed-1 from waveforms of two electric signals measured by the two detectors 33. Here, the touch position P in the second touch position detection direction x in the detection electrode Ed-1 is detected on the basis of a waveform of an electric signal detected by the detector 33 connected to the input end Ed (in) of the detection electrode Ed-1 and a waveform of an electric signal detected by the detector 33 connected to the output end Ed (out) of the detection electrode Ed-1.

In this case, in a case where the detectors 33 are voltmeters, the operation unit 35 detects the touch position P in the second touch position detection direction x in the detection electrode Ed-1 on the basis of an input voltage waveform Vi detected by the detector 33 connected to the input end Ed (in) and an output voltage waveform Vo detected by the detector 33 connected to the output end Ed (out).

On the other hand, in a case where the detectors 33 are ammeters, the operation unit 35 detects the touch position P in the second touch position detection direction x in the detection electrode Ed-1 on the basis of an input current waveform Ii detected by the detector 33 connected to the input end Ed (in) and an output current waveform Io detected by the detector 33 connected to the output end Ed (out).

A method of the multipoint detection of the touch positions P in the first touch position detection direction y and a method for detecting the touch position P in the second touch position detection direction x in the detection electrode Ed-1 in the operation unit 35 as described above will be specifically described below.

—Power Source 37—

The power source 37 is connected to one of the two detectors 33 that is connected to the input end Ed (in) of the detection electrode Ed-1. The power source 37 may either be an AC power source or be a DC power source as long as the power source 37 is capable of applying a predetermined voltage.

—Ground 39—

The ground 39 is connected to one of the two detectors 33 that is connected to the output end Ed (out) of the detection electrode Ed-1 and the power source 37. The ground 39 may either be a signal ground including a circuit pattern or be a frame ground such as a metal case on which the organic electroluminescence module 1 is disposed. The ground 39 may either be the same as or be different from the ground 23 of the electroluminescence element driving circuit unit 20.

<Operation of Organic Electroluminescence Module 1 (First Example)>

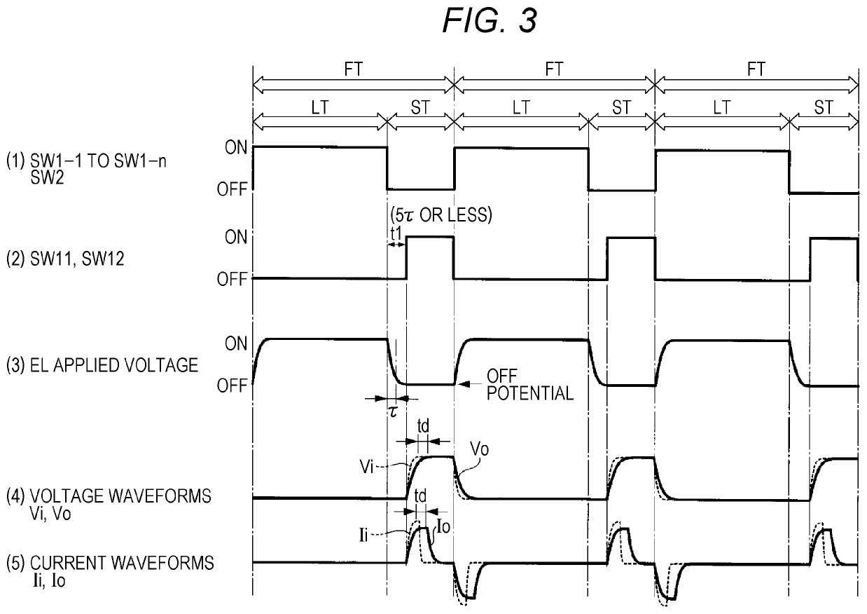

FIG. 3 is a timing chart illustrating a first example of an operation of the organic electroluminescence module 1 configured as described above and illustrating the operation of the organic electroluminescence module 1 performed by the electroluminescence element driving circuit unit 20 and the touch position detecting circuit unit 30.

FIG. 3 includes the following graphs.

(1) A graph showing an actuation timing of “ON”/“OFF” of the switches SW1-1, SW1-2, . . . and SW1-n and the switch SW2 in the electroluminescence element driving circuit unit 20.

(2) A graph showing an operation timing of “ON”/“OFF” of the switches SW11 and SW12 in the touch position detecting circuit unit 30.

(3) A graph showing a history of applied voltage in the organic electroluminescence element EL.

(4) A graph of the input voltage waveform Vi (wavy line) and the output voltage waveform Vo (solid line) detected by the detectors 33 in the touch position detecting circuit unit 30.

(5) A graph of the input current waveform Ii (wavy line) and the output current waveform Io (solid line) detected by the detectors 33 in the touch position detecting circuit unit 30.

In the graphs of (1) to (3) illustrated in FIG. 3, a high period indicates the “ON” state, and a low period indicates the “OFF” state. The same applies to other timing charts described below.

Hereinbelow, the first example of the operation of the organic electroluminescence module 1 will be described with reference to the timing chart of FIG. 3 and FIGS. 1 and 2.

As illustrated in FIG. 3, in an operation period in the organic electroluminescence module 1, a light emission period LT in which the organic electroluminescence element EL is caused to emit light and a touch position detection period ST in which the touch position P is detected are alternately repeated every one frame period FT. Driving of the electroluminescence element driving circuit unit 20 and the touch position detecting circuit unit 30 in each period and a method for detecting the touch position P executed in the operation unit 35 of the touch position detecting circuit unit 30 are as follows.

—Light Emission Period LT—

In the light emission period LT which is assigned to the first half of the frame period FT, the electroluminescence element driving circuit unit 20 brings the switches SW1-1, SW1-2, . . . and SW1-n and the switch SW2 into the “ON” state (1). On the other hand, the touch position detecting circuit unit 30 brings the switches SW11 and SW12 into the “OFF” state (2).

Accordingly, as illustrated in FIG. 1, the organic electroluminescence element EL and the light emission driving circuit 21 are connected to each other in the electroluminescence element driving circuit unit 20, which enables the light emission driving circuit 21 to control the light emission of the organic electroluminescence element EL. The light emission driving circuit 21 applies a constant current or a constant voltage to the organic electroluminescence element EL in the forward direction synchronously with the switches SW1-1, SW1-2, . . . and SW1-n and the switch SW2 becoming the “ON” state. Accordingly, as illustrated in FIG. 3, the applied voltage to the organic electroluminescence element EL rises from an “OFF” potential (3), and light emission is started at the point in time when the applied voltage becomes a current value or a voltage value required for the light emission.

On the other hand, in the touch position detecting circuit unit 30, the connected state between each of the detection electrodes Ed-1, Ed-2, . . . and Ed-n and each of the detectors 33 is released. Thus, no electric signal is measured in the detectors 33, and the touch position P cannot be detected.

—Touch Position Detection Period ST—

As illustrated in FIG. 3, in the touch position detection period ST which is assigned to the second half of the frame period FT, the electroluminescence element driving circuit unit 20 brings the switches SW1-1, SW1-2, . . . and SW1-n and the switch SW2 into the “OFF” state (1). On the other hand, the touch position detecting circuit unit 30 brings the switches SW11 and SW12 into the “ON” state (2).

Accordingly, as illustrated in FIG. 2, in the electroluminescence element driving circuit unit 20, the connection between the organic electroluminescence element EL and the light emission driving circuit 21 is released, so that the voltage application to the organic electroluminescence element EL is stopped. Thus, as illustrated in FIG. 3, the applied voltage to the organic electroluminescence element EL drops to the “OFF” potential (3), so that the organic electroluminescence element EL is turned off.

On the other hand, in the touch position detecting circuit unit 30, each of the detection electrodes Ed-1, Ed-2, . . . and Ed-n and each of the detectors 33 are brought into a connected state. Accordingly, (4) the input voltage waveform Vi (wavy line) and the output voltage waveform Vo (solid line) or (5) the input current waveform Ii (wavy line) and the output current waveform Io (solid line) can be measured in each of the detectors 33, and the touch position P is detected on the basis of the measured electric signals.

—Method for Detecting Touch Position P—Next, a method for detecting the touch position P performed in each of the operation units 35 on the basis of an electric signal detected in each of the detectors 33 will be described.

Specifically, each of the operation units 35 detects the touch position P on the basis of a waveform of an electric signal measured at the output end Ed (out) of each of the detection electrodes Ed-1, Ed-2, . . . and Ed-n. Here, a delay time td in the rising of the electric signal is detected from the waveform of the electric signal measured at the output end Ed (out).

For example, when (4) the input voltage waveform Vi (wavy line) and the output voltage waveform Vo (solid line) are obtained as electric signals, a delay time td between when the input voltage waveform Vi (wavy line) reaches a predetermined value and when the output voltage waveform Vo (solid line) reaches the predetermined value is detected. Further, when (5) the input current waveform Ii (wavy line) and the output current waveform Io (solid line) are obtained as electric signals, a delay time td between when the input current waveform Ii (wavy line) reaches a predetermined value and when the output current waveform Io (solid line) reaches the predetermined value is detected.

An output current value I measured at the output end Ed (out), a resistance value r between the input end Ed (in) and the output end Ed (out), a resistance value r1 between the input end Ed (in) and the touch position P, a resistance value r2 between the touch position P and the output end Ed (out), the delay time td, and time t have a relationship represented by the following equation (1).

I∝exp[−rt/(r1×r2)]=exp(−t/td) (1)

A delay time td when no touch operation is performed is defined as a reference value. For each of the detection electrodes Ed-1, Ed-2, . . . and Ed-n, when the calculated delay time td is larger than the reference value, it is determined that a touch operation has been performed from the above equation (1). On the other hand, when the calculated delay time td is equal to or smaller than the reference value, it is determined that no touch operation has been performed. In this manner, multipoint detection of the touch positions P in the first touch position detection direction y is performed.

Further, for each of the detection electrodes Ed-1, Ed-2, . . . and Ed-n, the ratio between the resistance value r1 between the input end Ed (in) and the touch position P and the resistance value r2 between the touch position P and the output end Ed (out) is calculated on the basis of the delay time td from the above equation (1), and a touch position P in the touch position detection direction x corresponding to the resistance value ratio is obtained.

In the touch position detection period ST, for example, the switches SW1-1, SW1-2, . . . and SW1-n and the switch SW2 of the electroluminescence element driving circuit unit 20 are brought into the “OFF” state simultaneously with the start of the period. However, even when the switches SW1-1, SW1-2, . . . and SW1-n and the switch SW2 become the “OFF” state, the organic electroluminescence element EL does not drop to the “OFF” potential so as to be turned off in a moment. The organic electroluminescence element EL is turned off after a certain time in accordance with a discharge time constant τ (1/e) of the organic electroluminescence element EL. Thus, in the touch position detection period ST, a predetermined standby period t1 is set after the start of the touch position detection period ST. Each of the switches SW11 and SW12 of the touch position detecting circuit unit 30 is brought into the “ON” state at the point in time when the standby period t1 elapses. The standby period t1 is set within the range of equal to or less than five times the discharge time constant τ of the organic electroluminescence element EL so as to bring the organic electroluminescence element EL into a fully discharged state, that is, into the “OFF” potential while minimizing the standby period t1. Accordingly, it is possible to stably measure a current value in each of the detectors 33 and detect the touch position P on the basis of a result of the measurement.

The length of the light emission period LT, the length of the touch position detection period ST, and the length of the frame period FT in the organic electroluminescence module 1 are not particularly limited to any length, and conditions suitable for an environment to be applied can be appropriately selected. As an example, the light emission period LT of the organic electroluminescence element EL is within the range of 0.1 msec to 2.0 msec, the touch position detection period ST is within the range of 0.05 msec to 0.3 msec, and the frame period FT is within the range of 0.15 msec to 2.3 msec. The frame period FT is preferably 60 Hz or more for the purpose of reducing flicker. A typical image display period may be used as the frame period FT.

When the length of the frame period FT is previously determined, the ratio between the light emission period LT and the touch position detection period ST within the frame period FT may be set to any ratio taking into consideration the accuracy of touch position detection in the organic electroluminescence module 1.

<Operation of Organic Electroluminescence Module 1 (Second Example)>

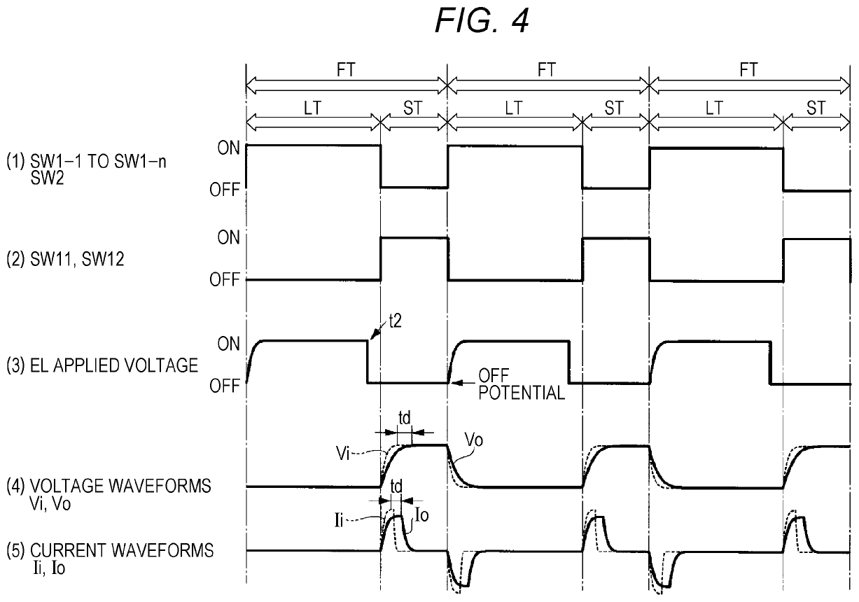

FIG. 4 is a timing chart illustrating a second example of the operation of the organic electroluminescence module 1 configured as described above. The second example illustrated in FIG. 4 differs from the first example illustrated in FIG. 3 in that a reverse voltage is applied to the organic electroluminescence element EL at the last timing t2 of the light emission period LT.

Hereinbelow, the second example of the operation of the organic electroluminescence module 1 will be described with reference to the timing chart of FIG. 4 and FIGS. 1 and 2. Redundant description for the same operation as the first example will be partially omitted.

As illustrated in FIG. 4, an operation period in the organic electroluminescence module 1 is similar to that in the first example in that the light emission period LT in which the organic electroluminescence element EL is caused to emit light and the touch position detection period ST in which touch position detection is performed are alternately repeated every one frame period FT. Driving as described below is performed in each of the periods.

—Light Emission Period LT—

In the second example, the light emission driving circuit 21 of the electroluminescence element driving circuit unit 20 applies a reverse voltage to the organic electroluminescence element EL (3) at the last timing t2 of the light emission period LT. At this time, the electroluminescence element driving circuit unit 20 maintains the SW1-1, SW1-2, . . . and SW1-n and a switch SW22 in the “ON” state (1), and the touch position detecting circuit unit 30 maintains the switches SW11 and SW12 in the “OFF” state (2). Accordingly, the organic electroluminescence element EL is brought into a completely discharged state, that is, into the “OFF” potential in a moment and thereby turned off.

—Touch Position Detection Period ST—

In the second example, the touch position detecting circuit unit 30 brings the switches SW11 and SW12 into the “ON” state (2) simultaneously with the start of the touch position detection period ST. At the point in time when the touch position detection period ST is started, the organic electroluminescence element EL is at the “OFF” potential (3) by the application of the reverse voltage described above. Thus, the standby period t1 (refer to FIG. 3) as set in the first example is not required. Even when the switches SW11 and SW12 are brought into the “ON” state (2) at the point in time when the touch position detection period ST is started in the light emission period LT, an electric signal is stably measured in each of the detectors 33. The touch position P can be detected on the basis of a result of the measurement.

—Method for Detecting Touch Position P—

Also in the second example, a method for detecting the touch position P performed in the operation unit 35 of the touch position detecting circuit unit 30 is similar to that of the first example.

<Effects of First Embodiment>

The organic electroluminescence module 1 of the first embodiment described above is capable of performing multipoint detection, that is, multi-touch detection of the touch positions P in the first touch position detection direction y by using the lower electrode 11 of the organic electroluminescence element EL as the detection electrodes Ed-1, Ed-2, . . . and Ed-n arranged separately in the first touch position detection direction y and measuring electric signals in each of the detection electrodes Ed-1, Ed-2, . . . and Ed-n. Further, it is also possible to perform touch position detection in the second touch position detection direction x on the basis of electric signals detected at the input end Ed (in) and the output end Ed (out) in the second touch position detection direction x of each of the detection electrodes Ed-1, Ed-2, . . . and Ed-n. Accordingly, it is not necessary to dispose a touch sensor, which is configured as a separate body, onto the organic electroluminescence element EL in an overlapping manner. Thus, it is possible to obtain the organic electroluminescence module with a touch function that achieves thinning and a reduction in the number of manufacturing steps.

In addition, the touch position detection period and the light emission period of the organic electroluminescence element EL are separated from each other. In the touch position detection period ST, the connection between the upper electrode 15 of the organic electroluminescence element EL and the electroluminescence element driving circuit unit 20 is released. Accordingly, in the touch position detection period, the upper electrode 15 as the counter electrode Eo with respect to the detection electrodes Ed-1, Ed-2, . . . and Ed-n is set at a floating potential. Thus, the parasitic capacitance Cel can be completely canceled after the elapse of the discharge time constant τ of the organic electroluminescence element EL.

The parasitic capacitance Cel between each of the pieces of the lower electrode 11 and the upper electrode 15 of the organic electroluminescence element EL is incomparably larger than a capacitance Cf between the fingertip F touching on the touch surface 10a and the detection electrodes Ed-1, Ed-2, . . . and Ed-n. Further, in a state where the detection electrodes Ed-1, Ed-2, . . . and Ed-n constituted of the lower electrode 11 are connected to the light emission driving circuit 21, a capacitance C which is detected in the detection electrodes Ed-1, Ed-2, . . . and Ed-n when the touch surface 10a is touched with the fingertip F is “Cf+Cel” which is the sum of the capacitance Cf between the fingertip F and the detection electrode Ed-1 and the parasitic capacitance Cel between the lower electrode 11 and the upper electrode 15 of the organic electroluminescence element EL. Thus, it is difficult to detect the capacitance Cf between the fingertip F and the detection electrode Ed-1 and thus difficult to detect the touch position P.

Thus, as described above, the touch position detection period and the light emission period are separated from each other, and the upper electrode 15 is set at a floating potential to cancel the parasitic capacitance Cel in the touch position detection period. Such a configuration enables the touch position P to be detected with high accuracy.

Further, in the touch position detection period, the switches SW1-1, SW1-2, . . . and SW1-n and the switch SW2 are brought into the “OFF” state to release the connection between each of the pieces of the lower electrode 11 as the detection electrodes Ed-1, Ed-2, . . . and Ed-n and the electroluminescence element driving circuit unit 20. Accordingly, it is possible to prevent the potential of the detection electrodes Ed-1, Ed-2, . . . and Ed-n from being affected by the parasitic capacitance generated in each part of the electroluminescence element driving circuit unit 20 in the touch position detection period.

Therefore, it is possible to detect the capacitance Cf between the fingertip F on the touch surface 10a and the detection electrodes Ed-1, Ed-2, . . . and Ed-n with high accuracy using the lower electrode 11, which is a component of the organic electroluminescence element EL, as the detection electrodes Ed-1, Ed-2, . . . and Ed-n and improve the accuracy of the touch position detection.

In the first embodiment described above, the switches SW1-1, SW1-2, . . . and SW1-n and the switch SW2 are provided for the lower electrode 11 and the upper electrode 15 of the organic electroluminescence element EL to freely release the connection between the organic electroluminescence element EL and the electroluminescence element driving circuit unit 20. However, when the potential of the detection electrodes Ed-1, Ed-2, . . . and Ed-n is less likely to be affected by the electroluminescence element driving circuit unit 20, the switch SW2 may be provided only for the counter electrode Eo with respect to the detection electrodes Ed-1, Ed-2, . . . and Ed-n so as to constantly connect the detection electrodes Ed-1, Ed-2, . . . and Ed-n to the electroluminescence element driving circuit unit 20.

### Second Embodiment

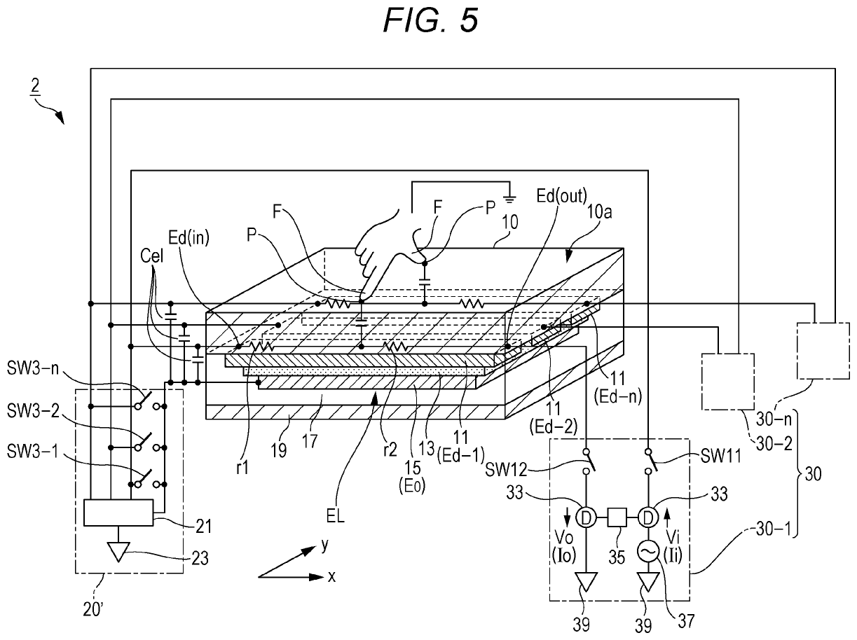

FIG. 5 is a configuration diagram for describing an organic electroluminescence module 2 of a second embodiment. The organic electroluminescence module 2 illustrated in FIG. 5 differs from the organic electroluminescence module 1 of the first embodiment described above with reference to FIGS. 1 and 2 in the configuration of an electroluminescence element driving circuit unit 20′. The other configuration is similar to that of the first embodiment. Thus, hereinbelow, the configuration of the electroluminescence element driving circuit unit 20′ will be described, and redundant description for other components will be omitted.

<Electroluminescence Element Driving Circuit Unit 20′>

The electroluminescence element driving circuit unit 20′ is configured to control light emission of the organic electroluminescence element EL and establish a short circuit between the lower electrode 11 and the upper electrode 15 of the organic electroluminescence element EL. The electroluminescence element driving circuit unit 20′ having such a configuration is provided with a light emission driving circuit 21 which is connected to the lower electrode 11 which is divided into a plurality of pieces and the upper electrode 15 in the organic electroluminescence element EL and switches SW3-1, SW3-2, . . . and SW3-n for establishing a short circuit between the lower electrode 11 and the upper electrode 15. The light emission driving circuit 21 is connected to a ground 23 and these configurations are similar to those of the first embodiment. The configuration of the switches SW3-1, SW3-2, . . . and SW3-n is as follows.

—Switches SW3-1, SW3-2, . . . and SW3-n—

The switches SW3-1, SW3-2, . . . and SW3-n are used for freely controlling a connected state between each of the pieces of the lower electrode 11 and the upper electrode 15. Each of the switches SW3-1, SW3-2, . . . and SW3-n having such a configuration includes, for example, a thin film transistor (TFT) and a control circuit which controls driving of the TFT. In this case, in each of the switches SW3-1, SW3-2, . . . and SW3-n, either a source or a drain of the TFT is connected to the lower electrode 11, and the other one is connected to the upper electrode 15. A gate electrode of the TFT is connected to the control circuit. Accordingly, the connected state between the lower electrode 11 and the upper electrode 15 is freely controlled by voltage applied to the gate electrode of the TFT.

Here, a state in which the lower electrode 11 and the upper electrode 15 are connected and short-circuited by driving the switches SW3-1, SW3-2, . . . and SW3-n is defined as an “ON” state of the switches SW3-1, SW3-2, . . . and SW3-n. On the other hand, a state in which the connections between the lower electrode 11 and the upper electrode 15 are released by driving the SW3-1, SW3-2, . . . and SW3-n is defined as an “OFF” state of the switches SW3-1, SW3-2, . . . and SW3-n.

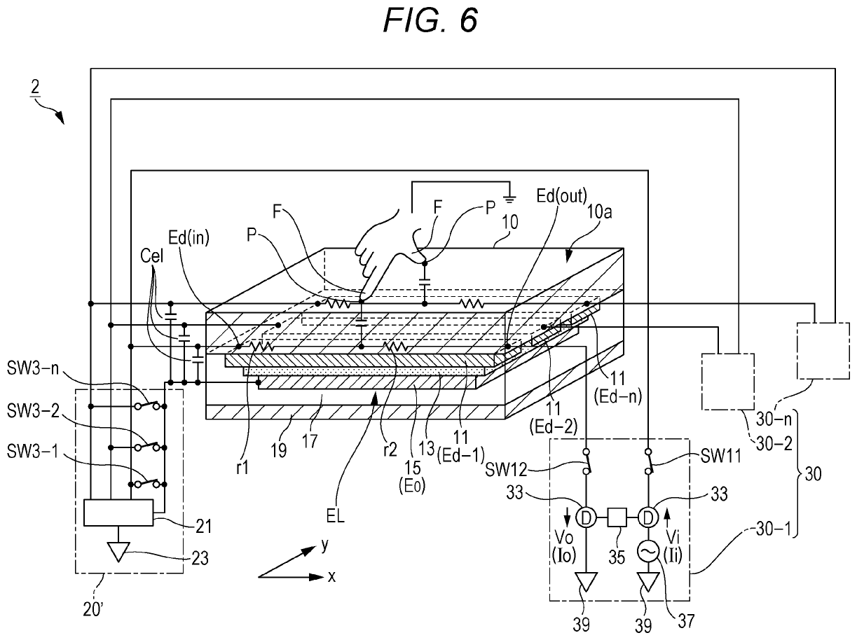

The control of “ON”/“OFF” of the switches SW3-1, SW3-2, . . . and SW3-n as described above is performed synchronously with the switches SW11 and SW12 of the touch position detecting circuit unit 30 as described below with reference to a timing chart. That is, when the switches SW11 and SW12 are in an “OFF” state, the switches SW3-1, SW3-2, . . . and SW3-n are brought into the “OFF” state (refer to FIG. 5). On the other hand, when the switches SW11 and W12 are in an “ON” state, the switches SW3-1, SW3-2, . . . and SW3-n are brought into the “ON” state (refer to FIG. 6).

FIGS. 5 and 6 illustrate a configuration in which the light emission driving circuit 21 and the switches SW3-1, SW3-2, . . . and SW3-n are separated from each other. However, the switches SW3-1, SW3-2, . . . and SW3-n may be incorporated in the light emission driving circuit 21 as needed. Further, the control circuits of the switches SW3-1, SW3-2, . . . and SW3-n may be an external operation device.

<Operation Example of Organic Electroluminescence Module 2>

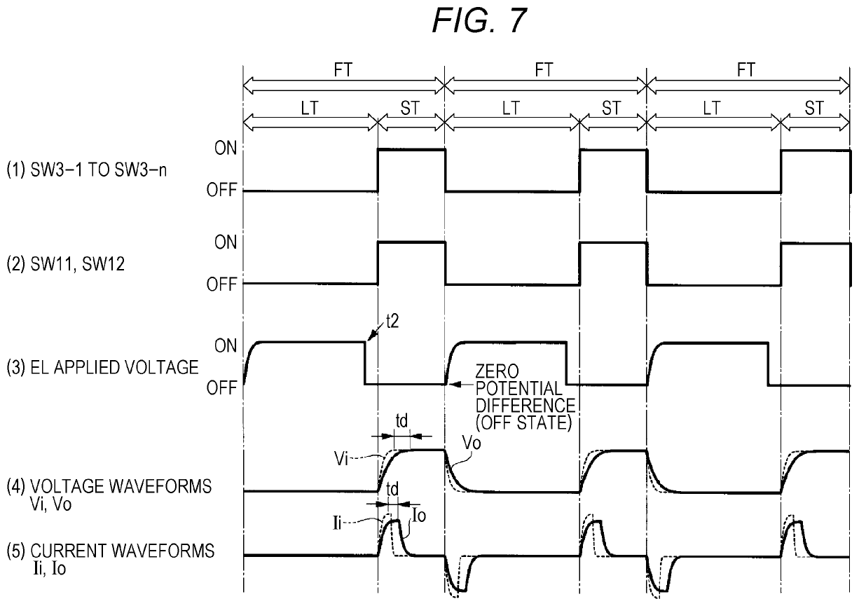

FIG. 7 is a timing chart illustrating an operation example of the organic electroluminescence module 2 configured as described above and illustrating the operation of the organic electroluminescence module 2 performed by the electroluminescence element driving circuit unit 20′ and the touch position detecting circuit unit 30. A first example of the operation illustrated in FIG. 7 corresponds to the first example of the operation described above in the first embodiment.

Each of graphs (1) to (5) of FIG. 7 is similar to each of the graphs in the timing chart of FIG. 3 described above in the first embodiment. However, the graph of (1) shows an actuation timing of “ON”/“OFF” of the switches SW3-1, SW3-2, . . . and SW3-n in the electroluminescence element driving circuit unit 20′.

Hereinbelow, the operation example of the organic electroluminescence module 2 will be described with reference to the timing chart of FIG. 7 and FIGS. 5 and 6.

In an operation period in the organic electroluminescence module 2, a light emission period LT in which the organic electroluminescence element EL is caused to emit light and a touch position detection period ST in which touch position detection is performed are alternately repeated every one frame period FT in a manner similar to that of the first embodiment. The length of the frame period FT, the length of the light emission period LT, and the length of the touch position detection period ST are similar to those of the first embodiment.

—Light Emission Period LT—

In the light emission period LT which is assigned to the first half of the frame period FT, the electroluminescence element driving circuit unit 20′ brings the switches SW3-1, SW3-2, . . . and SW3-n into the “OFF” state (1). Further, the touch position detecting circuit unit 30 brings the switches SW11 and SW12 into the “OFF” state (2).

Accordingly, as illustrated in FIG. 5, in the electroluminescence element driving circuit unit 20′, each of the pieces of the lower electrode 11 and the upper electrode 15 in the organic electroluminescence element EL are kept in an insulated state and connected to the light emission driving circuit 21. Thus, it becomes possible for the light emission driving circuit 21 to control light emission of the organic electroluminescence element EL. The light emission driving circuit 21 applies a constant current or a constant voltage to the organic electroluminescence element EL in the forward direction synchronously with the switches SW3-1, SW3-2, . . . and SW3-n becoming the “OFF” state. Accordingly, as illustrated in FIG. 7, the applied voltage to the organic electroluminescence element EL rises from an “OFF” potential (3), and light emission is started at the point in time when the applied voltage becomes a current value or a voltage value required for the light emission.

On the other hand, in the touch position detecting circuit unit 30, the connected state between the detection electrodes Ed-1, Ed-2, . . . and Ed-n and the detectors 33 is released. Thus, no electric signal is measured in the detectors 33, and the touch position P cannot be detected.

As illustrated in FIG. 7, the light emission driving circuit 21 of the electroluminescence element driving circuit unit 20′ applies the equal potentials to the lower electrode 11 and the upper electrode 15 at the last timing t2 of the light emission period LT. Accordingly, the organic electroluminescence element EL is brought into an “OFF” state in which a potential difference between the lower electrode 11 and the upper electrode 15 is “zero” and thereby turned off.

—Touch Position Detection Period ST—

As illustrated in FIG. 7, in the touch position detection period ST which is assigned to the second half of the frame period FT, the electroluminescence element driving circuit unit 20′ brings the switches SW3-1, SW3-2, . . . and SW3-n into the “ON” state (1) simultaneously with the start of the period. Further, the touch position detecting circuit unit 30 brings the switches SW11 and SW12 into the “ON” state (2) simultaneously with the start of the period. Further, the electroluminescence element driving circuit unit 20′ continuously applies equal potentials to the lower electrode 11 and the upper electrode 15.

Accordingly, as illustrated in FIG. 6, in the electroluminescence element driving circuit unit 20′, each of the pieces of the lower electrode 11 and the upper electrode 15 in the organic electroluminescence element EL are brought into a short-circuited state. Thus, it becomes impossible for the light emission driving circuit 21 to control light emission of the organic electroluminescence element EL. Further, as illustrated in FIG. 7, the applied voltage to the organic electroluminescence element EL is in the “OFF” state in which the potential difference between the lower electrode 11 and the upper electrode 15 is “zero” (3). Thus, the turned-off state of the organic electroluminescence element EL is maintained.

On the other hand, in the touch position detecting circuit unit 30, each of the detection electrodes Ed-1, Ed-2, . . . and Ed-n as the lower electrode 11 and each of the detectors 33 are brought into a connected state. Accordingly, (4) the input voltage waveform Vi (wavy line) and the output voltage waveform Vo (solid line) or (5) the input current waveform Ii (wavy line) and the output current waveform Io (solid line) can be measured in each of the detectors 33, and the touch position P is detected on the basis of the measured electric signals. At the point in time when the touch position detection period ST is started, the potential difference between the lower electrode 11 and the upper electrode 15 of the organic electroluminescence element EL is “zero”, and the parasitic capacitance Cel of the organic electroluminescence element EL is in a canceled state. Thus, the standby period t1 (refer to FIG. 3) as set in the first example of the first embodiment is not required. Even when the switches SW11 and SW12 are brought into the “ON” state at the point in time when the touch position detection period ST is started, the touch position detection can be stably performed.

—Method for Detecting Touch Position P—

A method for detecting the touch position P performed in the operation unit 35 on the basis of the measured electric signals is similar to that of the first embodiment.

In the second embodiment described above, the switches SW3-1, SW3-2, . . . and SW3-n are disposed between the lower electrode 11 and the upper electrode 15 of the organic electroluminescence element EL to freely control the connected state between the lower electrode 11 and the upper electrode 15. However, when the potential of the detection electrode Ed constituted of the lower electrode 11 is sufficiently stabilized by canceling the parasitic capacitance Cel of the organic electroluminescence element EL by making the potential difference between the lower electrode 11 and the upper electrode 15 “zero”, it is not necessary to provide the switches SW3-1, SW3-2, . . . and SW3-n. In this case, it is sufficient for the electroluminescence element driving circuit unit 20′ to only control voltage application to the lower electrode 11 and the upper electrode 15 by the light emission driving circuit 21 as described above in the operation example with reference to FIG. 7.

<Effects of Second Embodiment>

The organic electroluminescence module 2 of the second embodiment described above is also capable of performing multipoint detection of the touch positions P in the first touch position detection direction y and touch position detection in the second touch position detection direction x by using the lower electrode 11 of the organic electroluminescence element EL as the detection electrodes Ed-1, Ed-2, . . . and Ed-n arranged separately in the first touch position detection direction y in a manner similar to that of the first embodiment. Thus, the organic electroluminescence module with a touch function that achieves thinning and a reduction in the number of manufacturing steps is obtained

In addition, in the organic electroluminescence module 2 of the second embodiment, the touch position detection period and the light emission period of the organic electroluminescence element EL are separated from each other. In the touch position detection period, a short circuit is established between the upper electrode 15 and each of the pieces of the lower electrode 11 of the organic electroluminescence element EL. Accordingly, in the touch position detection period, the parasitic capacitance Cel of the organic electroluminescence element EL is canceled. Thus, in a manner similar to that of the first embodiment, it is possible to improve the accuracy of the touch position detection without being affected by the parasitic capacitance Cel of the organic electroluminescence element EL using the lower electrode 11, which is a component of the organic electroluminescence element EL, as the detection electrodes Ed-1, Ed-2, . . . and Ed-n.

<Combination to Configuration of Second Embodiment>

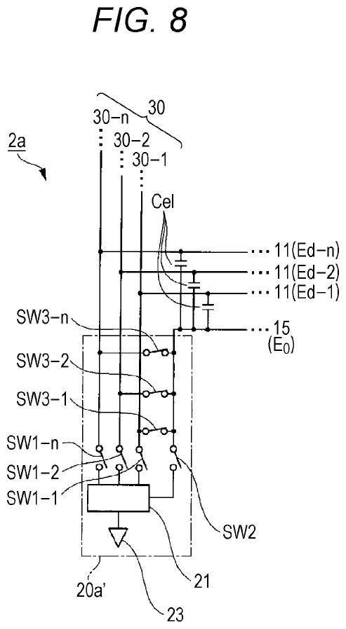

The configuration of the organic electroluminescence module 2 of the second embodiment can be combined with the configuration of the first embodiment. FIG. 8 is a configuration diagram for describing an organic electroluminescence module 2a which is a combination of the second embodiment and the first embodiment. FIG. 8 is a configuration diagram of the electroluminescence element driving circuit unit 20a′ for describing a touch position detection period.

As illustrated in FIG. 8, the electroluminescence element driving circuit unit 20a′ of the organic electroluminescence module 2a which is a combination of the second embodiment and the first embodiment is provided with the switches SW1-1, SW1-2, . . . and SW1-n which are disposed between the light emission driving circuit 21 and the lower electrode 11 and the switch SW2 which is disposed between the light emission driving circuit 21 and the upper electrode 15 together with the light emission driving circuit 21 and the switches SW3-1, SW3-2, . . . and SW3-n.

The configuration of the switches SW3-1, SW3-2, . . . and SW3-n and “ON”/“OFF” control thereof are similar to those of the second embodiment. The configuration of the switches SW1-1, SW1-2, . . . and SW1-n and “ON”/“OFF” control thereof are similar to those of the first embodiment. The switches are synchronously driven.

In the organic electroluminescence module 2a having such a configuration, it is possible to obtain the effects of the first embodiment in addition to the effects of the second embodiment.

That is, in the touch position detection period, the upper electrode 15 as the counter electrode Eo with respect to the detection electrodes Ed-1, Ed-2, . . . and Ed-n is set at a floating potential by bringing the switch SW2 into the “OFF” state, so that the parasitic capacitance Cel can be completely canceled. Further, in the touch position detection period, the switches SW1-1, SW1-2, . . . and SW1-n are brought into the “OFF” state to release the connection between the lower electrode 11 as the detection electrodes Ed-1, Ed-2, . . . and Ed-n and the electroluminescence element driving circuit unit 20a′. Accordingly, it is possible to prevent the potential of the detection electrodes Ed-1, Ed-2, . . . and Ed-n from being affected by the parasitic capacitance generated in each part of the light emission driving circuit 21.

Therefore, it is possible to detect the capacitance Cf between the fingertip F on the touch surface 10a and the detection electrodes Ed-1, Ed-2, . . . and Ed-n with high accuracy using the lower electrode 11, which is a component of the organic electroluminescence element EL, as the detection electrodes Ed-1, Ed-2, . . . and Ed-n and improve the accuracy of the touch position detection.

In the configuration described above, when the potential of the detection electrodes Ed-1, Ed-2, . . . and Ed-n is less likely to be affected by the electroluminescence element driving circuit unit 20a′, the switch SW2 may be provided only for the counter electrode Eo with respect to the detection electrodes Ed-1, Ed-2, . . . and Ed-n so as to constantly connect the detection electrodes Ed-1, Ed-2, . . . and Ed-n to the electroluminescence element driving circuit unit 20a′, which is similar to that of the first embodiment.

Further, in such a configuration, equal potentials may be applied to the lower electrode 11 and the upper electrode 15 from the electroluminescence element driving circuit unit 20a′ at the last timing t2 of the light emission period LT in a manner similar to that of the second embodiment. Further, when the equal potentials are not applied at the last timing t2, the standby period t1 is preferably set within the touch detection period ST in a manner similar to that of the first embodiment.

### Third Embodiment

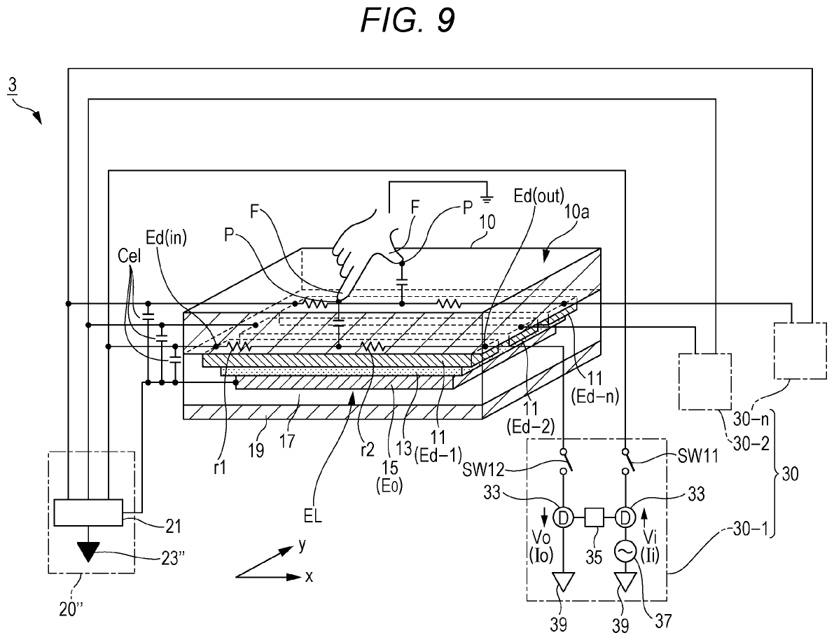

FIG. 9 is a configuration diagram for describing an organic electroluminescence module 3 of a third embodiment. The organic electroluminescence module 3 illustrated in FIG. 9 differs from the organic electroluminescence module 1 of the first embodiment described above with reference to FIGS. 1 and 2 in the configuration of an electroluminescence element driving circuit unit 20″. The other configuration is similar to that of the first embodiment. Thus, hereinbelow, the configuration of the electroluminescence element driving circuit unit 20″ will be described, and redundant description for other components will be omitted.

<Electroluminescence Element Driving Circuit Unit 20″>

The electroluminescence element driving circuit unit 20″ controls light emission of the organic electroluminescence element EL. The electroluminescence element driving circuit unit 20″ is provided with a light emission driving circuit 21 which is connected to the lower electrode 11 which is divided into a plurality of pieces and the upper electrode 15 in the organic electroluminescence element EL. The configuration of the light emission driving circuit 21 is similar to that of the first embodiment. The light emission driving circuit 21 is connected to a ground 23″ as described below.

—Ground 23″—

The ground 23″ may either be a signal ground including a circuit pattern or be a frame ground such as a metal case on which the organic electroluminescence module 3 is disposed. Here, in particular, it is important that the ground 23″ differs from the ground 39 in the touch position detecting circuit unit 30.

<Operation Example of Organic Electroluminescence Module 3>

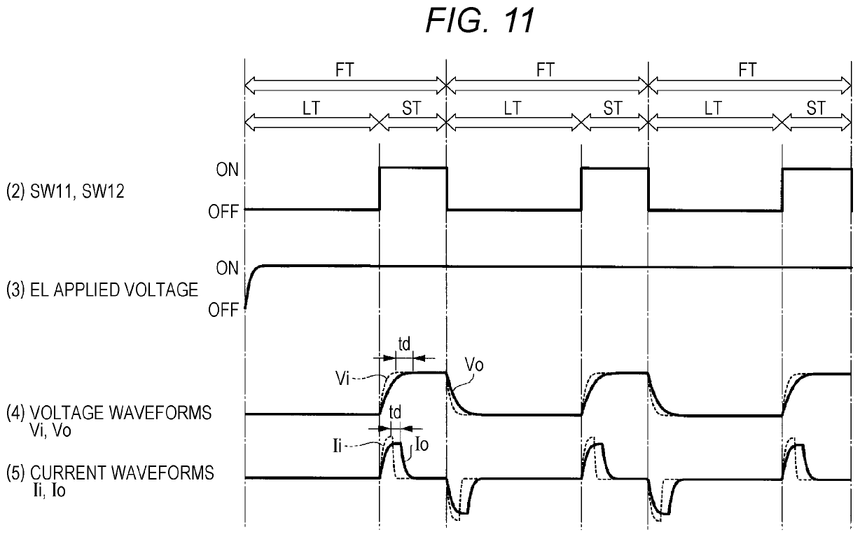

FIG. 11 is a timing chart illustrating an operation example of the organic electroluminescence module 3 configured as described above and illustrating the operation of the organic electroluminescence module 3 performed by the electroluminescence element driving circuit unit 20″ and the touch position detecting circuit unit 30.

Each of graphs (2) to (5) of FIG. 11 is similar to each of the graphs in the timing chart of FIG. 3 described above in the first embodiment.

Hereinbelow, the operation example of the organic electroluminescence module 3 will be described with reference to the timing chart of FIG. 11 and FIGS. 9 and 10.

In the organic electroluminescence module 3, the organic electroluminescence element EL is caused to continuously emit light during an operation period. Further, a touch position detection period ST in which touch position detection is performed is periodically set during the continuous light emission period. The touch position detection period ST is periodically repeated every one frame period FT. Accordingly, for example, the first half of the frame period FT corresponds to a light emission period LT in which only light emission of the organic electroluminescence element EL is performed without performing touch position detection, and the second half thereof corresponds to the touch position detection period ST in which touch position detection is performed. The length of the frame period FT, the length of the light emission period LT, and the length of the touch position detection period ST are similar to those of the first embodiment.

—Light Emission Period LT—

In the light emission period LT which is assigned to the first half of the frame period FT, the touch position detecting circuit unit 30 brings the switches SW11 and SW12 into an “OFF” state (2).

In the light emission period LT as described above, as illustrated in FIG. 9, the light emission driving circuit 21 can control light emission of the organic electroluminescence element EL. Accordingly, as illustrated in FIG. 11, the applied voltage to the organic electroluminescence element EL rises from an “OFF” potential immediately after the start of a drive period (3), and light emission is started at the point in time when the applied voltage becomes a current value or a voltage value required for the light emission.

On the other hand, in the touch position detecting circuit unit 30, the connected state between the detection electrodes Ed-1, Ed-2, . . . and Ed-n and the detectors 33 is released. Thus, the touch position P cannot be detected.

—Touch Position Detection Period ST—

As illustrated in FIG. 11, in the touch position detection period ST which is assigned to the second half of the frame period FT, the touch position detecting circuit unit 30 brings the switches SW11 and SW12 into an “ON” state (3).

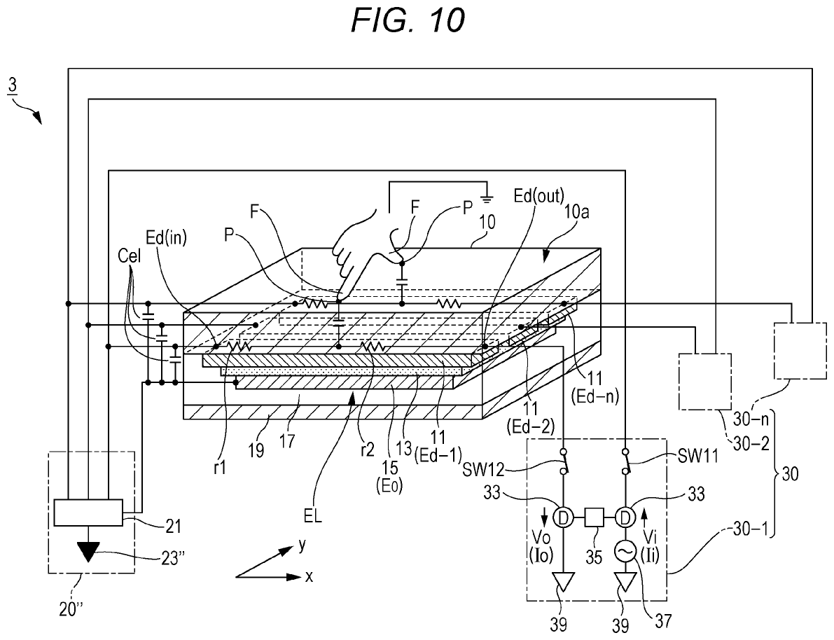

In the touch position detection period ST as described above, as illustrated in FIG. 10, the light emission driving circuit 21 can continuously control light emission of the organic electroluminescence element EL. Thus, as illustrated in FIG. 11, the applied voltage to the organic electroluminescence element EL is maintained in a light emission state (3).

On the other hand, in the touch position detecting circuit unit 30, the detection electrodes Ed-1, Ed-2, . . . and Ed-n and the detectors 33 are brought into a connected state. Accordingly, (4) the input voltage waveform Vi (wavy line) and the output voltage waveform Vo (solid line) or (5) the input current waveform Ii (wavy line) and the output current waveform Io (solid line) can be measured in each of the detectors 33, and the touch position P is detected on the basis of the measured electric signals.

—Method for Detecting Touch Position P—

A method for detecting the touch position P performed in the operation unit 35 on the basis of the measured electric signals is similar to that of the first embodiment.

<Effects of Third Embodiment>

The organic electroluminescence module 3 of the third embodiment described above is also capable of performing multipoint detection of the touch positions P in the first touch position detection direction y and touch position detection in the second touch position detection direction x by using the lower electrode 11 of the organic electroluminescence element EL as the detection electrodes Ed-1, Ed-2, . . . and Ed-n arranged separately in the first touch position detection direction y in a manner similar to that of the first embodiment. Thus, the organic electroluminescence module with a touch function that achieves thinning and a reduction in the number of manufacturing steps is obtained.

In addition, in the organic electroluminescence module 3 of the third embodiment, the light emission driving circuit 21 of the electroluminescence element driving circuit unit 20″ for driving the organic electroluminescence element EL is connected to the ground 23″ which differs from the ground to which the touch position detecting circuit unit 30 connected to the detection electrodes Ed-1, Ed-2, . . . and Ed-n is connected. Accordingly, the parasitic capacitance Cel of the organic electroluminescence element EL exerts no influence on the capacitance Cf between the detection electrodes Ed-1, Ed-2, . . . and Ed-n constituted of the lower electrode 11 and the fingertip F on the touch surface 10a. Thus, it is possible to improve the accuracy of the touch position detection.

<Combination to Configuration of Third Embodiment>

The configuration of the organic electroluminescence module 3 of the third embodiment can be combined with the configuration of the first embodiment or the configuration of the second embodiment, and can also be combined with both of the configurations of the first embodiment and the second embodiment. In the case of any of the combinations, it is possible to additionally obtain the effects of each of the combined embodiments.

### Fourth Embodiment

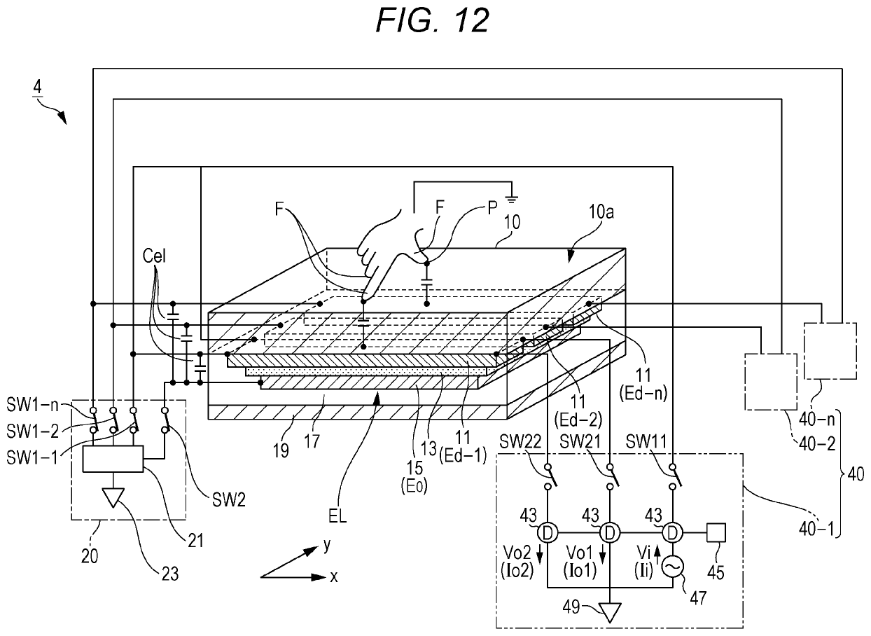

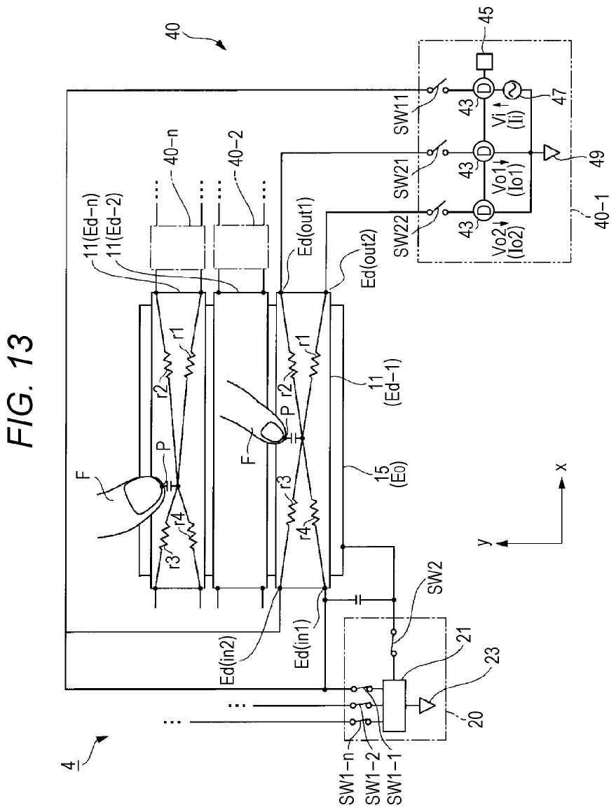

FIG. 12 is a configuration diagram for describing an organic electroluminescence module 4 of a fourth embodiment. FIG. 13 is a schematic plan view of the organic electroluminescence module 4. The organic electroluminescence module 4 illustrated in FIGS. 12 and 13 differs from the organic electroluminescence module 1 of the first embodiment described above with reference to FIGS. 1 and 2 in the configuration of a touch position detecting circuit unit 40. The other configuration is similar to that of the first embodiment. Thus, hereinbelow, the configuration of the touch position detecting circuit unit 40 will be described, and redundant description for other components will be omitted. FIG. 13 is a plan view of the organic electroluminescence module 4 viewed from the side corresponding to the detection electrodes Ed-1, Ed-2, . . . and Ed-n constituted of the lower electrode 11, in which the support substrate is not illustrated.

<Touch Position Detecting Circuit Unit 40>

The touch position detecting circuit unit 40 includes detection units 40-1, 40-2, . . . and 40-n which are respectively connected to the detection electrodes Ed-1, Ed-2, . . . and Ed-n constituted of the respective pieces of the lower electrode 11 of the organic electroluminescence element EL. All the detection electrodes Ed-1, Ed-2, . . . and Ed-n have the same configuration, and all the detection units 40-1, 40-2, . . . and 40-n have the same configuration. Thus, hereinbelow, the configuration of the detection unit 40-1 connected to the detection electrode Ed-1 will be described as an example.

The detection unit 40-1 is connected to four corners of the detection electrode Ed-1 including both ends in the first touch position detection direction y and both ends in the second touch position detection direction x. The detection electrode Ed-1, that is, the lower electrode 11 in the organic electroluminescence element EL as one example has a planar quadrangular shape. The detection unit 40-1 is connected to the four corners of the planar quadrangular detection electrode Ed-1. The detection unit 40-1 detects electric characteristics on the four corners of the detection electrode Ed-1 to detect a touch position P in the two-dimensional touch position detection directions x and y in the detection electrode Ed-1.

The detection unit 40-1 uses the respective ends on one direction side of the four corners of the detection electrode Ed-1 (lower electrode 11) as a first input end Ed (in1) and a second input end Ed (in2) and the respective ends on the other direction side thereof as a first output end Ed (out1) and a second output end Ed (out2). Here, the first input end Ed (in1) and the first output end Ed (out1) are diagonally located, and the second input end Ed (in2) and the second output end Ed (out2) are diagonally located.

Electric signals input from the first input end Ed (in1) and the second input end Ed (in2) are detected at the first output end Ed (out1) and the second output end Ed (out2) to detect the touch position P.

The touch position detecting circuit unit 40 having such a configuration is provided with switches SW11, SW21, and SW22 which are connected to the four corners of the detection electrode Ed-1, three detectors 43 which are connected to the respective switches SW11, SW21, and SW22, an operation unit 45 which is connected to the detectors 43, and a power source 47. The detectors 43 and the power source 47 are connected to a ground 49. Details of each of the components are as follows.

—Switches SW11, SW21, and SW22—

The switches SW11, SW21, and SW22 are used for freely controlling a connected state between the four corners of the detection electrode Ed-1 and the detectors 43. The switch SW11 is connected to the first input end Ed (in1) and the second input end Ed (in2) of the detection electrode Ed-1. On the other hand, the switch SW21 is connected to the first output end Ed (out1) of the detection electrode Ed-1, and the switch SW22 is connected to the second output end Ed (out2) of the detection electrode Ed-1.

Each of the switches SW11, SW21, and SW22 includes, for example, a thin film transistor (TFT) and a control circuit which controls driving of the TFT. In this case, in each of the switches S SW11, SW21, and SW22, either a source or a drain of the TFT is connected to the corresponding corner(s) of the detection electrode Ed-1, and the other one is connected to the detector 43. A gate electrode of the TFT is connected to the control circuit. Accordingly, the connected state between each of the four corners of the detection electrode Ed-1 and each of the detectors 43 is freely controlled by voltage applied to the gate electrode of the TFT.

A state in which the four corners of the detection electrode Ed-1 are connected to the detectors 43 as described above by driving the switches SW11, SW21, and SW22 is defined as an “ON” state of the switches SW11, SW21, and SW22. On the other hand, a state in which the connection between the detection electrode Ed-1 and the detectors 43 is released by driving the switches SW11, SW21, and SW22 is defined as an “OFF” state of the switches SW11, SW21, and SW22.

The switches SW11, SW21, and SW22 are driven synchronously with the switches SW1-1, SW1-2, . . . and SW1-n and the switch SW2 of the electroluminescence element driving circuit unit 20. When the switches SW1-1, SW1-2, . . . and SW1-n and the switch SW2 are in an “ON” state, the switches SW11, SW21, and SW22 are brought into the “OFF” state. On the other hand, when the switches SW1-1, SW1-2, . . . and SW1-n and the switch SW2 are in an “OFF” state, the switches SW11, SW21, and SW22 are brought into the “ON” state. The control circuits of the switches SW11, SW21, and SW22 may be an external operation device.

—Detectors 43—

The three detectors 43 are connected to the four corners of the detection electrode Ed-1 though the switches SW11, SW21, and SW22. One of the three detectors 43 is connected to the first input end Ed (in1) and the second input end Ed (in2) of the detection electrode Ed-1 through the switch SW11. Another one of the three detectors 43 is connected to the first output end Ed (out1) through the switch SW21, and the rest one is connected to the second output end Ed (out2) through the switch SW22.

Each of the detectors 43 is either a voltmeter or an ammeter. The detectors 43 measure voltage values or current values applied to the first input end Ed (in1) and the second input end Ed (in2) and the first output end Ed (out1) and the second output end Ed (out2) of the detection electrode Ed-1 as electric signals.

—Operation Unit 45—

The operation unit 45 detects a touch position P. Specifically, the operation unit 45 detects a position in the touch position detection directions x and y on the touch surface 10a in the detection electrode Ed-1 to which a touch operation has been performed from electric signals measured by the three detectors 43. Here, the touch position P is detected on the basis of a waveform of an electric signal detected by the detector 43 connected to the first input end Ed (in1) and the second input end Ed (in2) and waveforms of electric signals detected by the two detector 43 connected to the first output end Ed (out1) and the second output end Ed (out2).

In this case, in a case where the detectors 43 are voltmeters, the operation unit 45 detects the touch position P on the basis of an input voltage waveform Vi detected by the detector 43 connected to the first input end Ed (in1) and the second input end Ed (in2) and output voltage waveforms Vo1 and Vo2 detected by the two detector 43 connected to the first output end Ed (out1) and the second output end Ed (out2).

On the other hand, in a case where the detectors 43 are ammeters, the operation unit 45 detects the touch position P on the basis of an input current waveform Ii detected by the detector 43 connected to the first input end Ed (in1) and the second input end Ed (in2) and output current waveforms Io1 and Io2 detected by the two detector 43 connected to the first output end Ed (out1) and the second output end Ed (out2).

The above method for detecting the touch position P in the operation unit 45 will be specifically described below.

—Power Source 47—

The power source 47 is connected to one of the three detectors 43 that is connected to the first input end Ed (in1) and the second input end Ed (in2) of the detection electrode Ed-1. The power source 47 may either be an AC power source or be a DC power source as long as the power source 47 is capable of applying a predetermined voltage.

—Ground 49—

The ground 49 is connected to two of the three detectors 43 that are connected to the first input end Ed (in1) and the second input end Ed (in2) of the detection electrode Ed-1 and the power source 47. The ground 49 may either be a signal ground including a circuit pattern or be a frame ground such as a metal case on which the organic electroluminescence module 4 is disposed.

<Operation of Organic Electroluminescence Module 4>

Driving of the organic electroluminescence module 4 having the above configuration is performed in a manner similar to that in the first example and the second example of the operation described above in the first embodiment. In this case, the switches SW11 and SW12 in the description for the operation in the first embodiment correspond to the switches SW11, SW21, and SW22.

—Method for Detecting Touch Position P—

In the method for detecting the touch position P performed in the operation unit 45 on the basis of measured electric signals, the method described above in the first embodiment is applied to waveforms of two electric signals detected at the first output end Ed (out1) and the second output end Ed (out2). The method for detecting the touch position P in a case where voltage waveforms are obtained as electric signals is as follows.

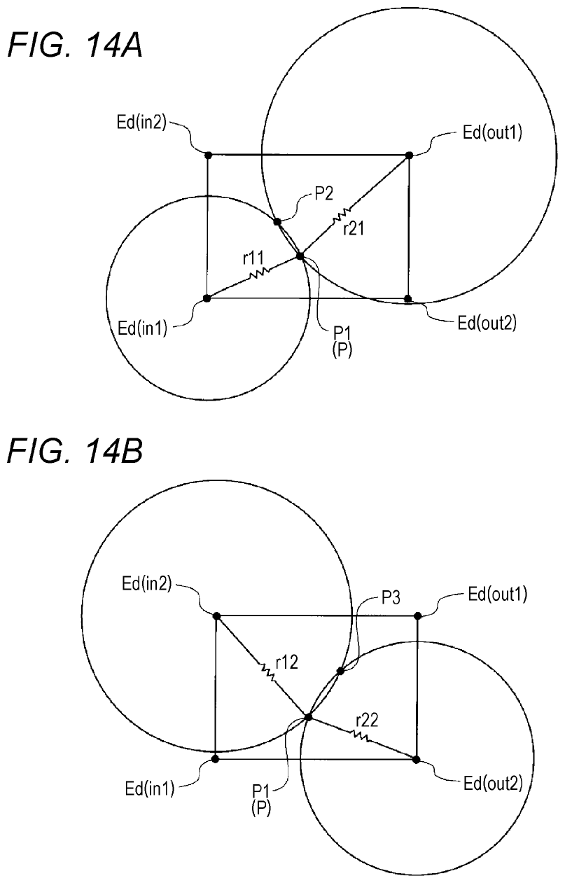

As illustrated in FIG. 14A, the operation unit 45 detects a delay time td between when the input voltage waveform Vi at the first input end Ed (in1) reaches a predetermined value and when the output voltage waveform Vo at the first output end Ed (out1) which is diagonally located with respect to the first input end Ed (in1) reaches the predetermined value to detect a touch position P in a manner similar to that of the first embodiment. At this time, the detected touch position P includes two touch positions P1 and P2.

Further, as illustrated in FIG. 14B, the operation unit 45 detects a delay time td between when the input voltage waveform Vi at the second input end Ed (in2) reaches a predetermined value and when the output voltage waveform Vo at the second output end Ed (out2) which is diagonally located with respect to the second input end Ed (in2) reaches the predetermined value to detect a touch position P in a manner similar to that of the first embodiment. At this time, the detected touch position P includes two touch positions P1 and P3.

Thus, the operation unit 45 selects the touch position P1 which has been detected in common in the above two detections as the touch position P.

The above method can also be applied to the case where current waveforms are obtained as electric signals in a similar manner.

<Effects of Fourth Embodiment>

The organic electroluminescence module 4 of the fourth embodiment as described above is capable of performing multipoint detection of the touch positions P in the first touch position detection direction y in which the detection electrodes Ed-1, Ed-2, . . . and Ed-n are arrayed and also capable of performing detailed touch position detection in the two-dimensional directions within the range of the detection electrodes Ed-1, Ed-2, . . . and Ed-n at each of the detected touch positions. The fourth embodiment can obtain effects similar to those of the first embodiment. Further, since the touch position detection in the two-dimensional directions can be performed in each of the detection electrodes Ed-1, Ed-2, . . . and Ed-n, it is possible to perform touch position detection with higher resolution than that of the other embodiments.

<Combination to Configuration of Fourth Embodiment>

The configuration of the organic electroluminescence module 4 of the fourth embodiment can be combined with the configuration of the second embodiment or the configuration of the third embodiment, and can also be combined with both of the configurations of the second embodiment and the third embodiment. In the case, the electroluminescence element driving circuit unit 20 illustrated in FIG. 12 may be replaced with the electroluminescence element driving circuit unit of the second embodiment or the third embodiment, or a combination of the second embodiment and the third embodiment. Accordingly, it is possible to obtain the effects peculiar to each of the embodiments.

<<First Application Example of Organic Electroluminescence Module>>

In the above first to fourth embodiments, there has been described the configuration in which the detection electrodes Ed-1, Ed-2, . . . and Ed-n are arranged separately only in the first touch position detection direction y. However, the present invention is not limited to the described configuration and may have a configuration in which the detection electrodes Ed-1, Ed-2, . . . and Ed-n are arranged separately also in a direction that differs from the first touch position detection direction y. Accordingly, it is possible to perform multipoint detection of the touch positions P in two-dimensional touch position detection directions.

<<Second Application Example of Organic Electroluminescence Module>>

In the electroluminescence module in each of the embodiments described above, the touch position detecting circuit unit detects which one of the detection electrode Ed-1, Ed-2, . . . and Ed-n corresponds to a position where a touch operation has been performed in the first touch position detection direction y. Thus, the touch position detecting circuit unit is configured to feed the detected touch position P back to the light emission driving circuit of the electroluminescence element driving circuit unit. The light emission driving circuit is configured to apply voltage for causing the organic electroluminescence element to emit light to any of the detection electrodes Ed-1, Ed-2, . . . and Ed-n corresponding to the touch position P and the upper electrode 15 in causing the organic electroluminescence element to emit light. Accordingly, it is possible to emit light only in a part corresponding to the touch position P in the first touch position detection direction y.

<<Third Application Example of Organic Electroluminescence Module>>

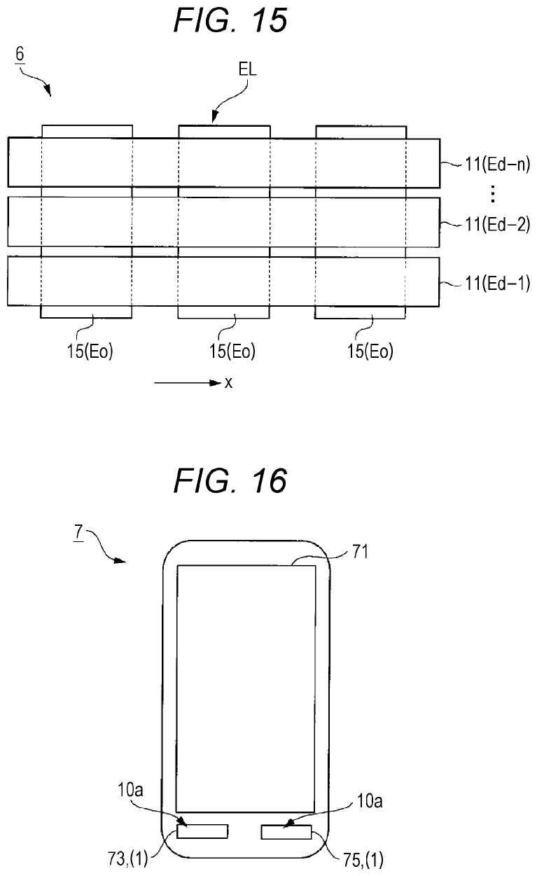

FIG. 15 is a plan view for describing a third application example of the organic electroluminescence module. An organic electroluminescence module 6 illustrated in FIG. 15 has a configuration in which, for example, the upper electrode 15 of the organic electroluminescence module 1 of the first embodiment described above with reference to FIG. 1 is divided into a plurality of pieces in the second touch position detection direction x. Here, as an example, the upper electrode 15 is divided into three pieces in the second touch position detection direction x. FIG. 15 is a plan view of the organic electroluminescence module 6 viewed from the side corresponding to the detection electrodes Ed-1, Ed-2, . . . and Ed-n constituted of the lower electrode 11, in which the support substrate is not illustrated.

Each of the three pieces of the upper electrode 15 (counter electrodes Eo) divided as described above is connected to the electroluminescence element driving circuit unit (not illustrated), and voltage is individually applied thereto. On the other hand, both ends in the second touch position detection direction x of each of the detection electrodes Ed-1, Ed-2, . . . and Ed-n constituted of the lower electrode 11 are connected to the touch position detecting circuit unit (not illustrated).

With such a configuration, the touch position detecting circuit unit detects which one of the detection electrodes Ed-1, Ed-2, . . . and Ed-n corresponds to a position where a touch operation has been performed in the first touch position detection direction y. Similarly, the touch position detecting circuit unit detects which one of the pieces of the upper electrode 15 corresponds to a position where the touch operation has been performed in the second touch position detection direction x.

Thus, the touch position detecting circuit unit is configured to feed the detected touch position P back to the light emission driving circuit of the electroluminescence element driving circuit unit. The light emission driving circuit is configured to apply voltage for causing the organic electroluminescence element to emit light to the detection electrode Ed-1, Ed-2, . . . or Ed-n and the piece of the upper electrode 15 corresponding to the detected touch position P in causing the organic electroluminescence element to emit light. Accordingly, it is possible to emit light only in a part corresponding to the touch position P in the touch position detection directions x and y.

The organic electroluminescence module 6 of the third application example as described above may have a configuration in which the upper electrode 15 of the organic electroluminescence module 2 of the second embodiment described above with reference to FIG. 5, the upper electrode 15 of the organic electroluminescence module 3 of the third embodiment described above with reference to FIG. 9, or the upper electrode 15 of the organic electroluminescence module 4 of the fourth embodiment described above with reference to FIG. 12 is divided into a plurality of pieces in the touch position detection direction x.

<<Smart Device>>

FIG. 16 is a plan view of a smart device that uses an organic electroluminescence module. The smart device 7 illustrated in FIG. 16 is provided with the organic electroluminescence module of the present invention described above in the first to fourth embodiments and the first to third application examples.

The smart device 7 includes a main display unit 71 and icons 73 and 75 as function key buttons. The organic electroluminescence module of the present invention described above in any of the first to fifth embodiments and the first to third application examples is used as each of the icons 73 and 75. Here, for example, the organic electroluminescence module 1 of the first embodiment is used.

The main display unit 71 includes, for example, a liquid crystal display device. The main display unit 71 is an “in-cell” type or “on-cell” type display unit which has a built-in sensor function. The organic electroluminescence module 1 as each of the icons 73 and 75 is disposed with the touch surface 10a facing the front side.

For example, the icons 73 and 75 may be patterned in various display patterns such as a “home key” indicated by, for example, a quadrangular mark and a “return key” indicated by, for example, an arrow mark. The icons 73 and 75 may be used as a screen scroll key, a volume control key, or a brightness control key, or may be configured to feed the detected touch position back to cause a controlled position to emit light.

The icons 73 and 75 as described above may have a configuration in which, for example, the display pattern is not visually recognized when the organic electroluminescence module 1 is in a non-light emitting state and visually recognized by bringing the organic electroluminescence module 1 into a light emitting state by a touch onto the surface thereof (that is, the touch surface 10a).

<<Illumination Apparatus>>

The organic electroluminescence module of the present invention can also be used in an illumination apparatus. As illumination apparatuses provided with the organic electroluminescence module of the present invention, the organic electroluminescence module is also effectively used in a home-use illumination, an in-vehicle illumination, a backlight of a liquid crystal display device, and a display device. In addition, there are wide range of uses such as a backlight of a watch or a clock, an advertising sign, a traffic signal, a light source of an optical storage medium, a light source of an electrophotographic copying machine, a light source of an optical communication processing device, a light source of an optical sensor, and common household electric appliances that require a display device.

For example, it is possible to perform brightness adjustment with feedback of information of a touch operation by using the organic electroluminescence module of the present invention in such illumination apparatuses to add a touch position detection function.

In the first to fourth embodiments and the first to third application examples described above, there has been described the configuration of the organic electroluminescence module in which one of the pair of electrodes (the lower electrode 11 and the upper electrode 15) included in the organic electroluminescence element EL, the one electrode being closer to the touch surface 10a, is used as the detection electrodes Ed-1, Ed-2, . . . and Ed-n. However, the organic electroluminescence module of the present invention is not limited to the described configuration. When the electrode located farther from the touch surface 10a includes a part projecting from the electrode closer to the touch surface 10a in plan view, it is possible to obtain effects similar to the effects described above by setting a touch position detection direction in the projecting part and using the projecting part as the detection electrodes Ed-1, Ed-2, . . . and Ed-n with a similar operation.

### REFERENCE SIGNS LIST

1, 2, 2a, 3, 4, 6: organic electroluminescence module (illumination apparatus)
7: smart device
11: lower electrode
13: organic light emitting function layer
15: upper electrode
20, 20′, 20″: electroluminescence element driving circuit unit
30, 40: touch position detecting circuit unit
23, 23″: ground (electroluminescence element driving circuit unit)
39, 49: ground (touch position detecting circuit unit)
EL: organic electroluminescence element
Ed-1, Ed-2, . . . and Ed-n: detection electrode
Ed (in): input end
Ed (in1): first input end
Ed (in2): second input end
Ed (out): output end
Ed (out1): first output end
Ed (out2): second output end
Eo: counter electrode
P: touch position
LT: light emission period
ST: touch position detection period
y: first touch position detection direction
x: second touch position detection direction

1. An organic electroluminescence module comprising:
an organic electroluminescence element including a pair of electrodes and an organic light emitting function layer disposed between the electrodes;
an electroluminescence element driving circuit unit that is connected to the pair of electrodes and controls light emission of the organic electroluminescence element; and
a touch position detecting circuit unit connected to both ends in a touch position detection direction of one of the pair of electrodes that serves as detection electrodes, wherein
the detection electrodes are arranged separately in the touch position detection direction, and
the touch position detecting circuit unit detects, for each of the detection electrodes, an electric signal input from an input end that is one of the ends of the detection electrode at an output end that is the other end of the detection electrode to perform touch position detection at at least one location in the touch position detection direction.

2. The organic electroluminescence module according to claim 1, wherein the touch position detecting circuit unit performs the touch position detection in a periodic touch position detection period.

3. The organic electroluminescence module according to claim 2, wherein the electroluminescence element driving circuit unit sets the other one of the pair of electrodes at a floating potential as a counter electrode in the touch position detection period.

4. The organic electroluminescence module according to claim 2, wherein the electroluminescence element driving circuit unit releases a connection with the pair of electrodes in the touch position detection period.

5. The organic electroluminescence module according to claim 2, wherein the electroluminescence element driving circuit unit causes the organic electroluminescence element to emit light in a light emission period between the touch position detection period and the next touch position detection period and applies a reverse voltage to the organic electroluminescence element at the last of the light emission period.

6. The organic electroluminescence module according to claim 2, wherein the electroluminescence element driving circuit unit establishes a short circuit between the pair of electrodes in the touch position detection period.

7. The organic electroluminescence module according to claim 6, wherein the electroluminescence element driving circuit unit causes the organic electroluminescence element to emit light in a light emission period between the touch position detection period and the next touch position detection period and applies equal potentials to the pair of electrodes at the last of the light emission period.

8. The organic electroluminescence module according to claim 2, wherein the electroluminescence element driving circuit unit and the touch position detecting circuit unit are connected to grounds that are independent of each other.

9. The organic electroluminescence module according to claim 1, wherein the touch position detecting circuit unit performs the touch position detection on the basis of a waveform of the electric signal detected at the output end.

10. The organic electroluminescence module according to claim 1, wherein the touch position detecting circuit unit detects electric signals input from two input ends at two output ends to perform touch position detection in each of the detection electrodes, the two input ends being respective ends on one direction side and the two output ends being respective ends on the other direction side of four corners in two-dimensional directions in each of the detection electrodes, the each of the two-dimensional directions being the touch position detection direction.

11. The organic electroluminescence module according to claim 1, wherein
one of the pair of electrodes in the organic electroluminescence element includes a touch surface where the touch position is detected, and
one of the pair of electrodes closer to the touch surface is used as the detection electrodes.

12. The organic electroluminescence module according to claim 2, wherein the electroluminescence element driving circuit unit causes the organic electroluminescence element to emit light in a light emission period between the touch position detection period and the next touch position detection period.

13. A smart device comprising the organic electroluminescence module according to claim 1.

14. An illumination apparatus comprising the organic electroluminescence module according to claim 1.

15. The organic electroluminescence module according to claim 2, wherein the touch position detecting circuit unit performs the touch position detection on the basis of a waveform of the electric signal detected at the output end.

16. The organic electroluminescence module according to claim 2, wherein the touch position detecting circuit unit detects electric signals input from two input ends at two output ends to perform touch position detection in each of the detection electrodes, the two input ends being respective ends on one direction side and the two output ends being respective ends on the other direction side of four corners in two-dimensional directions in each of the detection electrodes, the each of the two-dimensional directions being the touch position detection direction.

17. The organic electroluminescence module according to claim 2, wherein
one of the pair of electrodes in the organic electroluminescence element includes a touch surface where the touch position is detected, and
one of the pair of electrodes closer to the touch surface is used as the detection electrodes.

18. A smart device comprising the organic electroluminescence module according to claim 2.

19. An illumination apparatus comprising the organic electroluminescence module according to claim 2.

20. The organic electroluminescence module according to claim 3, wherein the electroluminescence element driving circuit unit sets the other one of the pair of electrodes at a floating potential as a counter electrode in the touch position detection period.
